(19) United States
(12) Patent Application Publication
(10) Pub. No.: US 2025/0389991 A1
(43) Pub. Date: Dec. 25, 2025

(54) LIQUID CRYSTAL LIGHT CONTROL DEVICE AND LIGHTING DEVICE

(71) Applicant: Japan Display Inc., Tokyo (JP)

(72) Inventors: Kojiro IKEDA, Tokyo (JP); Takeo KOITO, Tokyo (JP); Tae KUROKAWA, Tokyo (JP)

(21) Appl. No.: 19/314,315

(22) Filed: Aug. 29, 2025

Related U.S. Application Data
(63) Continuation of application No. PCT/JP2024/008003, filed on Mar. 4, 2024.

(30) Foreign Application Priority Data
Mar. 15, 2023 (JP) 2023-040635

(51) Int. Cl. G02F 1/1343; G02F 1/139

(52) U.S. Cl. CPC G02F 1/134309; G02F 1/1396

(57) ABSTRACT

A liquid crystal light control device includes a first liquid crystal cell, a second liquid crystal cell, and a third liquid crystal cell, each of which includes a first substrate arranged on a light-incident side, a second substrate arranged on a light-emitting side, and a liquid crystal layer between the first substrate and the second substrate, the first liquid crystal cell, the second liquid crystal cell, and the third liquid crystal cell overlapping each other in the light emission direction of light emitted from a light source. The first/third liquid crystal cells include a first electrode including first/second strip electrodes arranged on one of the first substrate and the second substrate. The second liquid crystal cell includes a first electrode including first/second strip electrodes arranged on the first substrate, and a second electrode including third/fourth strip electrodes arranged on the second substrate.

### CROSS-REFERENCE TO RELATED APPLICATIONS

This application is a Continuation of International Patent Application No. PCT/JP2024/008003, filed on Mar. 4, 2024, which claims the benefit of priority to Japanese Patent Application No. 2023-040635, filed on Mar. 15, 2023, the entire contents of which are incorporated herein by reference.

### FIELD

The present invention relates to a liquid crystal light control device that controls the light distribution of light emitted from a light source by utilizing the electro-optical effect of liquid crystals. The present invention also relates to a lighting device equipped with a liquid crystal light control device.

### BACKGROUND

A liquid crystal light control device that controls the spread of light from a light source by utilizing the property of liquid crystals to change their refractive index in response to an applied voltage is being developed.

The liquid crystal light control device has a structure in which, for example, four liquid crystal cells overlap. It is possible to create a lighting space by incorporating liquid crystal cells into lighting equipment, and to enhance the added value of a product. Incidentally, lighting devices used in various locations need to be miniaturized depending on their application.

### SUMMARY

A liquid crystal light control device in an embodiment according to the present invention includes a first liquid crystal cell, a second liquid crystal cell, and a third liquid crystal cell. Each of the first liquid crystal cell, the second liquid crystal cell, and the third liquid crystal cell includes a first substrate arranged on a light incident side, a second substrate arranged on a light output side, and a liquid crystal layer between the first substrate and the second substrate. The first liquid crystal cell, the second liquid crystal cell, and the third liquid crystal cell are arranged overlapping each other in the direction of light emission from a light source. The first liquid crystal cell includes a first electrode comprising a first strip electrode and a second strip electrode arranged on one of the first substrate and the second substrate, the second liquid crystal cell includes a first electrode comprising a first strip electrode and a second strip electrode arranged on the first substrate, and a second electrode comprising a third strip electrode and a fourth strip electrode arranged on the second substrate, and the third liquid crystal cell includes a first electrode comprising a first strip electrode and a second strip electrode arranged on one of the first substrate and the second substrate.

### BRIEF DESCRIPTION OF DRAWINGS

FIG. 1A is a schematic diagram of a liquid crystal light control device according to an embodiment of the present invention.

FIG. 1B is a schematic diagram of a liquid crystal light control device according to an embodiment of the present invention.

FIG. 1C is a schematic diagram of a liquid crystal light control device according to an embodiment of the present invention.

FIG. 1D is a schematic diagram of a liquid crystal light control device according to an embodiment of the present invention.

FIG. 2A is a schematic diagram of a liquid crystal light control device according to an embodiment of the present invention.

FIG. 2B is a schematic diagram of a liquid crystal light control device according to an embodiment of the present invention.

FIG. 2C is a schematic diagram of a liquid crystal light control device according to an embodiment of the present invention.

FIG. 2D is a schematic diagram of a liquid crystal light control device according to an embodiment of the present invention.

FIG. 3A is a schematic diagram of a liquid crystal light control device according to an embodiment of the present invention.

FIG. 3B is a schematic diagram of a liquid crystal light control device according to an embodiment of the present invention.

FIG. 3C is a schematic diagram of a liquid crystal light control device according to an embodiment of the present invention.

FIG. 3D is a schematic diagram of a liquid crystal light control device according to an embodiment of the present invention.

FIG. 4A is a schematic diagram of a liquid crystal light control device according to an embodiment of the present invention.

FIG. 4B is a schematic diagram of a liquid crystal light control device according to an embodiment of the present invention.

FIG. 4C is a schematic diagram of a liquid crystal light control device according to an embodiment of the present invention.

FIG. 4D is a schematic diagram of a liquid crystal light control device according to an embodiment of the present invention.

FIG. 5A is a photograph showing the light distribution of a liquid crystal light control device according to an embodiment of the present invention.

FIG. 5B is a photograph showing the light distribution of a liquid crystal light control device according to an embodiment of the present invention.

FIG. 6 is a graph showing the light distribution characteristics of a liquid crystal light control device according to an embodiment of the present invention.

FIG. 7 is a graph showing the light distribution characteristics of a liquid crystal light control device according to an embodiment of the present invention.

FIG. 8 is a diagram showing a configuration of liquid crystal light control device according to an embodiment of the present invention.

FIG. 9 is a graph showing the light distribution characteristics of a liquid crystal light control device according to an embodiment of the present invention.

FIG. 10 is a diagram showing a configuration of lighting device including a liquid crystal light control device according to an embodiment of the present invention.

FIG. 11 is a perspective view showing the structure of a liquid crystal cell configuring a liquid crystal light control device according to an embodiment of the present invention.

FIG. 12A is a plan view of an electrode of a liquid crystal cell configuring a liquid crystal light control device according to an embodiment of the present invention.

FIG. 12B is a plan view of an electrode of a liquid crystal cell configuring a liquid crystal light control device according to an embodiment of the present invention.

FIG. 13A is a diagram for explaining the operation of a liquid crystal cell configuring liquid crystal light control device according to an embodiment of the present invention and shows the alignment state of liquid crystal molecules when a voltage is applied.

FIG. 13B is a diagram for explaining the operation of a liquid crystal cell configuring liquid crystal light control device according to an embodiment of the present invention and shows the alignment state of liquid crystal molecules when a voltage is applied.

FIG. 14 is a diagram showing a relationship between a voltage applied to a liquid crystal cell configuring a liquid crystal light control element according to an embodiment of the present invention and light distribution.

FIG. 15A is a diagram showing a waveform of a control signal applied to a liquid crystal cell configuring a liquid crystal light control device according to an embodiment of the present invention.

FIG. 15B is a diagram showing a waveform of a control signal applied to a liquid crystal cell configuring a liquid crystal light control device according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are convenient terms used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

The term “optical rotation” as used herein refers to a phenomenon in which a linearly polarized component rotates its polarization axis as it passes through the liquid crystal layer.

The term “alignment direction” of an alignment film herein refers to the direction in which the liquid crystal molecules are aligned on the alignment film by a treatment (for example, rubbing treatment) that imparts an alignment restricting force on the alignment film. When the treatment performed on the alignment film is a rubbing treatment, the alignment direction of the alignment film is usually the rubbing direction.

The “direction of extension” of a strip electrode herein refers to the direction in which the long side of a pattern having a short side (width) and a long side (length) extends when the strip pattern is viewed in a plan view.

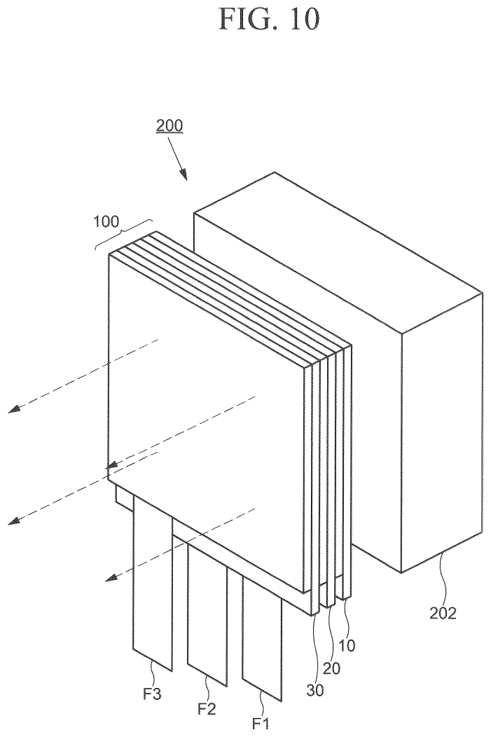

FIG. 10 is a perspective view of a lighting device 200 according to an embodiment of the present invention. The lighting device 200 includes a liquid crystal light control device 100 and a light source 202. The liquid crystal light control device 100 includes a structure in which a first liquid crystal cell 10, a second liquid crystal cell 20, and a third liquid crystal cell 30 are arranged from the side of the light source 202. A transparent adhesive layer (not shown) is arranged between the first liquid crystal cell 10 and the second liquid crystal cell 20 and between the second liquid crystal cell 20 and the third liquid crystal cell 30. The liquid crystal light control device 100 includes a structure in which the liquid crystal cells arranged adjacent to each other in front and rear are bonded by the transparent adhesive layer.

The liquid crystal light control device 100 is connected to a control circuit (not shown) and its operation is controlled. The liquid crystal light control device 100 and the control circuit are connected by a flexible wiring board. Specifically, the first flexible wiring board F1 is connected to the first liquid crystal cell 10, the second flexible wiring board F2 is connected to the second liquid crystal cell 20, and the third flexible wiring board F3 is connected to the third liquid crystal cell 30.

The lighting device 200 shown in FIG. 10 is configured such that light emitted from the light source 202 is emitted to the front side of the drawing through the liquid crystal light control device 100. The light source 202 includes a white light source, and optical elements such as a lens may be arranged between the white light source and the liquid crystal light control device 100 as required. The white light source is a light source which emits light close to natural light, and may be a light source which emits dimmed light, such as natural white light or light bulb color. The light source 202 preferably includes a light source having a narrow light distribution range and preferably has a structure such as an LED light source combined with a reflector and a lens.

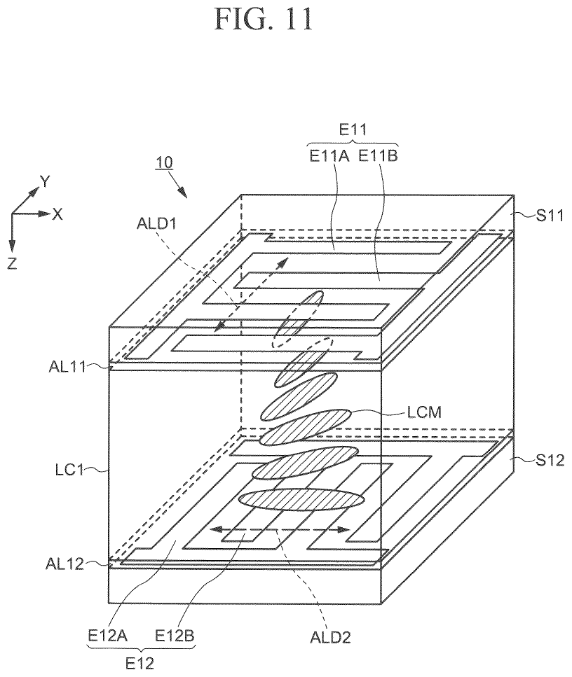

FIG. 11 is a perspective view showing the liquid crystal cell 10. The liquid crystal cell 10 includes a first substrate S11, a second substrate S12, a first electrode E11, a second electrode E12, a first alignment film AL11, a second alignment film AL12, and a first liquid crystal layer LC1. The first electrode E11 is arranged on the first substrate S11, and the second electrode E12 is arranged on the second substrate S12. The first alignment film AL11 is arranged on the first substrate S11 to cover the first electrode E11, and the second alignment film AL12 is arranged on the second substrate S12 to cover the second electrode E12. The liquid crystal layer LC1 is arranged between the first substrate S11 and the second substrate S12. The first electrode E11 and the second electrode E12 are arranged to face each other across the first liquid crystal layer LC1.

The first electrode E11 includes a first strip electrode E11A and a second strip electrode E11B having a strip-like pattern (or a comb-shaped pattern). The second electrode E12 includes a third strip electrode E12A and a fourth strip electrode E12B having a strip-like pattern (or a comb-shaped pattern). The first strip electrode E11A and the second strip electrode E11B are alternately arranged on the insulating surface of the first substrate S11, and the third strip electrode E12A and the fourth strip electrode E12B are alternately arranged on the insulating surface of the second substrate S12.

FIG. 11 shows the X, Y and Z-axis directions for illustration. In the liquid crystal cell 10, the direction of extension of the first strip electrode E11A and the second strip electrode E11B is parallel to the X-axis direction, and the direction of extension of the third strip electrode E12A and the fourth strip electrode E12B is parallel to the Y-axis direction. That is, the third strip electrode E12A and the fourth strip electrode E12B are arranged to intersect the first strip electrode E11A and the second strip electrode E11B. The direction of extension of the first strip electrode E11A and the second strip electrode E11B intersects with the direction of extension of the third strip electrode E12A and the fourth strip electrode E12B, for example, within a range of 90═10 degrees, and preferably orthogonally (90 degrees).

An extending direction of the strip electrodes configuring the first electrode E11 and the second electrode E12 may be inclined by ±10 degrees with respect to the X-axis and the Y-axis. The strip electrode may be partially bent while extending in a predetermined direction. In this case, the strip electrode has a plurality of extension directions in the longitudinal direction, but each extension direction may be inclined by ±10 degrees with respect to the X-axis or the Y-axis. Similarly, the strip electrode may be partially curved while extending in a predetermined direction. In this case, the tangential direction at each position of the strip electrode is regarded as the extending direction, and each extending direction may be inclined by ±10 degrees with respect to the X-axis or the Y-axis.

An alignment direction ALD1 of the first alignment film AL11 is arranged in a direction (Y-axis direction) intersecting the direction of extension of the first strip electrode E11A and the second strip electrode E11B, and an alignment direction ALD2 of the second alignment film AL12 is arranged in a direction (X-axis direction) intersecting the direction of extension of the third strip electrode E12A and the fourth strip electrode E12B. The angle between the direction of extension of the first strip electrode E11A and the second strip electrode E11B and the alignment direction ALD1, and the angle between the direction of extension of the third strip electrode E12A and the fourth strip electrode E12B and the alignment direction ALD2 can be set within a range of 90±10 degrees.

The distance (Hereinafter, also referred to as “cell gap”.) between the first substrate S11 and the second substrate S12 can be appropriately set in the range of 10 μm to 100 μm, preferably 15 μm to 55 μm. The film thicknesses of the first electrode E11, the second electrode E12, and the first alignment film AL11 and the second alignment film AL12 are negligibly small compared with the distance between the first substrate S11 and the second substrate S12. Therefore, the distance between the first substrate S11 and the second substrate S12 can be regarded as the thickness of the first liquid crystal layer LC1. Although not shown in FIG. 11, spacers may be arranged between the first substrate S11 and the second substrate S12 for maintaining a constant distance.

The first liquid crystal layer LC1 is, for example, a twisted nematic liquid crystal (TN liquid crystal). When a voltage is not applied to the first electrode E11 and the second electrode E12, the first liquid crystal layer LC1, which is affected by the alignment restricting force of the first alignment film AL11 and the second alignment film AL12, aligns the long axis direction of the liquid crystal molecules LCM parallel to the alignment direction ALD1 and ALD2 of the alignment films. Since the alignment direction ALD1 of the first alignment film AL11 and the alignment direction ALD2 of the second alignment film AL12 cross (perpendicular to each other), the alignment direction of the liquid crystal molecules LCM gradually changes such that the long axis direction is twisted by 90 degrees from the first substrate S11 to the second substrate S12.

When a voltage is applied to the initial alignment state of the liquid crystal molecules LCM shown in FIG. 11 so that a potential difference is generated between the first strip electrode E11A and the second strip electrode E11B, the alignment state of the liquid crystal molecules LCM on the first substrate S11 side is changed. The alignment state of the liquid crystal molecules LCM on the second substrate S12 side is changed by applying a voltage such that a potential difference is generated between the third strip electrode E12A and the fourth strip electrode E12B.

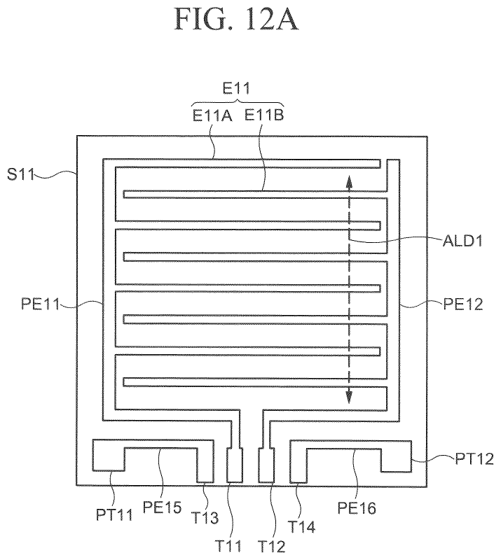

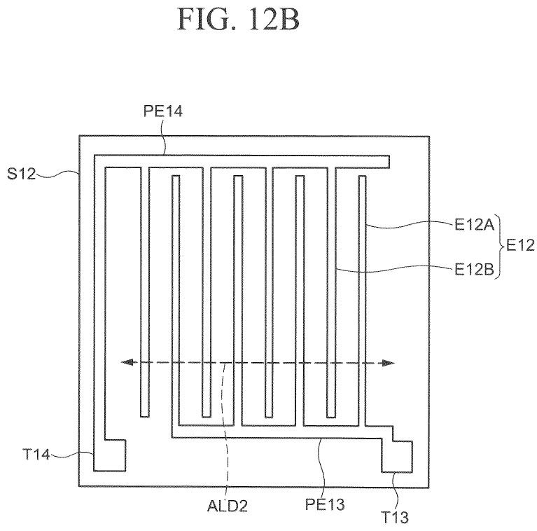

FIG. 12A is a plan view of the first substrate S11, and FIG. 12B is a plan view of the second substrate S12. As shown in FIG. 12A and FIG. 12B, the first electrode E11 includes a plurality of first strip electrodes E11A and a plurality of second strip electrodes E11B alternately arranged at predetermined distances, and the second electrode E12 includes a plurality of third strip electrodes E12A and a plurality of fourth strip electrodes E12B alternately arranged at predetermined distances.

As shown in FIG. 12A, each of the plurality of first strip electrodes E11A is connected to a first power supply line PE11, and each of the plurality of second strip electrodes E11B is connected to a second power supply line PE12. The first power supply line PE11 is connected to a first connecting terminal T11, and the second power supply line PE12 is connected to a second connecting terminal T12. The first connecting terminal T11 and the second connecting terminal T12 are arranged along one side of the end of the first substrate S11. A third connecting terminal T13 is arranged adjacent to the first connecting terminal T11, and a fourth connecting terminal T14 is arranged adjacent to the second connecting terminal T12 on the first substrate S11. The third connecting terminal T13 is connected to a fifth power supply line PE15. The fifth power supply line PE15 is connected to a first power supply terminal PT11 arranged at a predetermined position in the surface of the first substrate S11. The fourth connecting terminal T14 is connected to a sixth power supply line PE16. The sixth power supply line PE16 is connected to a second connecting terminal PT12 arranged at a predetermined position in the surface of the first substrate S11.

The plurality of first strip electrodes E11A is connected to the first power supply line PE11 so that the same voltage is applied. The plurality of second strip electrodes E11B is connected to the second power supply line PE12 so that the same voltage is applied. When different voltages are applied to the first connecting terminal T11 and the second connecting terminal T12, an electric field is generated between the plurality of first strip electrodes E11A and the plurality of second strip electrodes E11B.

As shown in FIG. 12B, each of the plurality of third strip electrodes E12A is connected to a third power supply line PE13, and each of the plurality of fourth strip electrodes E12B is connected to a fourth power supply line PE14. The third power supply line PE13 is connected to the third connecting terminal T13, and the fourth power supply line PE14 is connected to the fourth connecting terminal T14. A third power supply terminal PT13 is arranged at a position corresponding to the first power supply terminal PT11 of the first substrate S11, and a fourth power supply terminal PT14 is arranged at a position corresponding to the second power supply terminal PT12 of the first substrate S11. The third power supply terminal PT13 and the first power supply terminal PT11, and the fourth power supply terminal PT14 and the second power supply terminal PT12 are electrically connected. A conductive paste is used for electrical connection between these power supply terminals. For example, silver paste is used as the conductive paste.

When different voltages are applied to the third connecting terminal T13 and the fourth connecting terminal T14, an electric field is generated between the plurality of third strip electrodes E12A and the plurality of fourth strip electrodes E12B. That is, a transverse electric field is generated by the plurality of third strip electrodes E12A and the plurality of fourth strip electrodes E12B.

The first substrate S11 and the second substrate S12 are light-transmitting substrates, for example, glass substrates and resin substrates. The first electrode E11 and the second electrode E12 are transparent electrodes formed of a transparent conductive material such as indium tin oxide (ITO) or indium zinc oxide (IZO). The power supply line (first power supply line PE11, second power supply line PE12, third power supply line PE13, fourth power supply PE14) and the connecting terminal (first connecting terminal T11, second connecting terminal T12, third connecting terminal T13, fourth connecting terminal T14) are formed of a metal material such as aluminum, titanium, molybdenum, and tungsten. The power supply lines (the first power supply line PE11, the second power supply line PE12, the third power supply line PE13, and the fourth power supply line PE14) may be formed of the same transparent conductive film as the first electrode E11 and the second electrode E12. Either one or both of the first electrode E11 and the second electrode E12 may be formed of a metal material or a transparent conductive film laminated with a metal material.

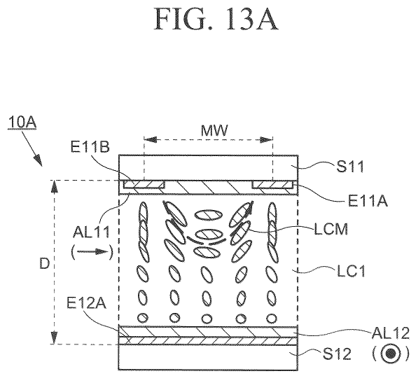

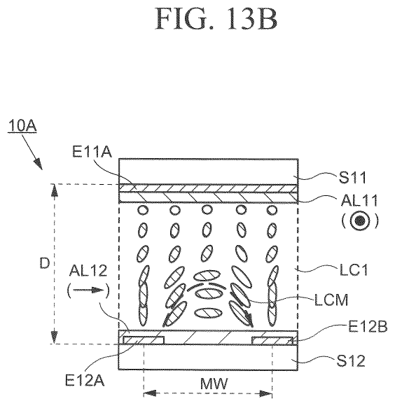

FIG. 13A shows a partial cross-sectional view of the liquid crystal cell 10 viewed from a direction perpendicular to the direction in which the third strip electrode E12A extends, and FIG. 13B shows a partial cross-sectional view of the liquid crystal cell 10 as viewed from a direction perpendicular to the direction in which the first strip electrode E11A extends. The fact that the alignment direction ALD1 of the first alignment film AL11 is different from the alignment direction ALD2 of the second alignment film AL12 is indicated by symbols in FIG. 13A and FIG. 13B.

As shown in FIG. 13A and FIG. 13B, the first substrate S11 and the second substrate S12 are arranged to face each other at a distance D. As described above, the distance D is a distance between substrates, which substantially corresponds to the thickness of the first liquid crystal layer LC1. FIG. 13A and FIG. 13B show center-to-center distances MW between the first strip electrode E11A and the second strip electrode E11B, and between the third strip electrode E12A and the fourth strip electrode E12B.

The distance D corresponding to the thickness of the first liquid crystal layer LC1 is preferably equal to or larger than the center-to-center distance MW of the strip electrodes (D≥MW). That is, the distance D is preferably one or more times as long as the center-to-center distance MW. For example, the distance D corresponding to the thickness of the first liquid crystal layer LC1 is preferably at least twice as large as the center-to-center distance MW of the strip-like electrodes. For example, when the center-to-center distance MW is 16 μm, the distance D corresponding to the thickness of the first liquid crystal layer LC1 is preferably 16 μm or more, for example, 20 μm is preferable, and 30 μm is more preferable.

Since the center-to-center distance MW of the strip electrodes and the distance D corresponding to the thickness of the first liquid crystal layer LC1 have such a relationship, interference between an electric field generated between the first strip electrode E11A and the second strip electrode E11B and an electric field generated between the third strip electrode E12A and the fourth strip electrode E12B is prevented.

It is known that the refractive index of liquid crystals changes depending on the alignment state. When the first liquid crystal layer LC1 is in an off (OFF) state in which an electric field is not applied, the long axis direction of the liquid crystal molecules LCM is aligned horizontally with the surface of the substrate and is aligned in a state twisted by 90 degrees from the first substrate S11 side to the second substrate S12 side. At this time, the first liquid crystal layer LC1 has a uniform refractive index distribution. When light is incident on the liquid crystal cell 10, the polarized component of the incident light changes its direction due to the twisting of the liquid crystal molecules LCM. In this case, the incident light passes through the first liquid crystal layer LC1 without being refracted (or scattered) while being optically rotated.

On the other hand, as shown in FIG. 13A, when an electric field is generated between the first strip electrode E11A and the second strip electrode E11B, the long axis of the liquid crystal molecules LCM is aligned along the electric field (when the liquid crystal has positive dielectric anisotropy). As a result, as shown in FIG. 13A, the first liquid crystal layer LC1 has a region where liquid crystal molecules LCM rise above the first strip electrode E11A and the second strip electrode E11B, and a region where the liquid crystal molecules LCM are aligned obliquely along the electric field distribution between the first strip electrode E11A and the second strip electrode E11B, and a region where the initial alignment state is maintained in a region away from the first substrate S11.

Similarly, as shown in FIG. 13B, when the third strip electrode E12A and the fourth strip electrode E12B are turned on (ON) so that an electric field is generated between them, the first liquid crystal layer LC1 has a region where liquid crystal molecules LCM rise above the third strip electrode E12A and the fourth strip electrode E12B, a region where the liquid crystal molecules LCM are aligned obliquely along the electric field distribution between the third strip electrode E12A and the fourth strip electrode E12B, and a region where the initial alignment state is maintained in the region away from the second substrate S12.

Hereinafter, the electric field generated by the first strip electrode E11A and the second strip electrode E11B, and the third strip electrode E12A and the fourth strip electrode E12B is also referred to as a “lateral electric field.”

As shown in FIG. 13A and FIG. 13B, when an electric field is generated between the first strip electrode E11A and the second strip electrode E11B, and between the third strip electrode E12A and the fourth strip electrode E12B, a region is formed where the liquid crystal molecules LCM are aligned in a convex arc shape with the long axis of the liquid crystal molecules in the direction of the electric field. That is, as shown in FIG. 13A, when the direction of the initial alignment of the liquid crystal molecules LCM and the direction of the lateral electric field generated between the first strip electrode E11A and the second strip electrode E11B are the same, the liquid crystal molecules LCM are aligned by tilting in the normal direction with respect to the surface of the first substrate S11 in accordance with the intensity distribution of the electric field.

At this time, as shown in FIG. 13A, since the distance D corresponding to the thickness of the first liquid crystal layer LC1 is sufficiently large, the effect of the electric field on the alignment of the liquid crystal molecules on the second substrate S12 side is extremely small, and the alignment state of the liquid crystal molecules LCM on the second substrate S12 side is hardly affected by the electric field generated on the first substrate S11 side. The same is true for FIG. 13B, the alignment state of the liquid crystal molecules LCM on the second substrate S12 side changes under the influence of the electric field generated by the third strip electrode E12A and the fourth strip electrode E12B, but the liquid crystal molecules LCM on the first substrate S11 side are hardly affected by this electric field.

By forming the lateral electric field by the strip electrodes, the convex arc-shaped dielectric constant distribution is formed in the first liquid crystal layer LC1. Among the light incident on the first liquid crystal layer LC1, the polarized component parallel to the initial alignment direction of the liquid crystal molecules LCM is diffused radially by the dielectric constant distribution. As shown in FIG. 13A and FIG. 13B, the direction of the initial alignment of the liquid crystal molecules LCM intersects (is orthogonal) between the first substrate S11 side and the second substrate S12 side, so that light can be diffused in different directions on the first substrate S11 side and the second substrate S12 side.

In this way, when light passes through the liquid crystal cell 10, some of the polarized components are transmitted while diffusing depending on the formation state of the electric field in the first liquid crystal layer LC1, and the remaining polarized components are transmitted as they are through the first liquid crystal layer LC1.

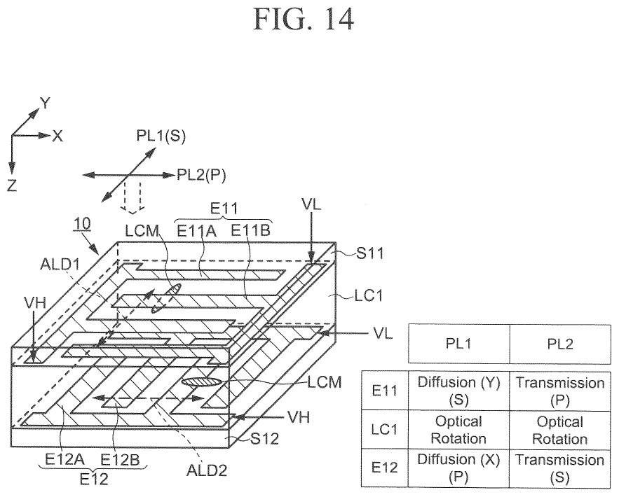

FIG. 14 shows that the first strip electrode E11A and the second strip electrode E11B of the first electrode E11 extend in the X-axis direction, and the third strip electrode E12A and the fourth strip electrode E12B of the second electrode E12 extend in the Y-axis direction in the liquid crystal cell 10. FIG. 14 also shows a state in which a voltage VH is applied to the first strip electrode E11A, a voltage VL (VL<VH) is applied to the second strip electrode E11B, the voltage VH is applied to the third strip electrode E12A, and the voltage VL (VL<VH) is applied to the fourth strip electrode E12B. With such voltage application conditions, a lateral electric field is generated in the Y-axis direction on the first substrate S11 side, and a lateral electric field is generated in the X-axis direction on the second substrate S12 side.

FIG. 14 shows that the light emitted from the light source has a first polarized component PL1 and a second polarized component PL2, and that the first polarized component PL1 corresponds to an S-wave and the second polarized component PL2 corresponds to a P-wave. Here, the S-wave has an amplitude in the Y-axis direction, and the P-wave has an amplitude in the X-axis direction. As shown in the table inserted in FIG. 14, light incident on the liquid crystal cell 10 undergoes optical effects such as transmission, optical rotation, and diffusion. “Transmission” in the table refers to transmission without any change in the polarization axis of a predetermined polarized component or in the light distribution state. As mentioned above, “optical rotation” refers to the phenomenon in which the polarization axis of the linearly polarized component rotates when it passes through the liquid crystal layer. Then, “diffusion (X)” indicates that the polarized component diffuses in the X-axis direction, and “diffusion (Y)” indicates that the polarized component diffuses in the Y-axis direction. The notation shown in the table shown in FIG. 14 is the same in each of the embodiments described below.

FIG. 14 shows a situation in which light containing a first polarized component PL1 (S-wave) and a second polarized component PL2 (P-wave) is incident on the liquid crystal cell 10 and is emitted from the second substrate S12.

Although not shown, the alignment direction ALD1 of the first alignment film AL1 is parallel to the X-axis, the alignment direction ALD2 of the second alignment film AL2 is parallel to the Y-axis, and the alignment direction of the liquid crystal molecules LCM of the first liquid crystal layer LC1 is affected by the alignment restricting force of these alignment films. Therefore, the long axis of the liquid crystal molecules LCM on the first substrate S11 side is in the Y-axis direction, and the long axis of the liquid crystal molecules LCM on the second substrate S12 side is in the X-axis direction.

The light of the first polarized component PL1 among the light incident from the first substrate S11 is in the S-wave, and since the polarization direction is parallel to the long axis direction of the liquid crystal molecules LCM on the first electrode E11 side, it diffuses in the Y-axis direction due to the influence of the arc-shaped refractive index distribution formed by the alignment of the liquid crystal molecules LCM. Then, the first polarized component PL1 passes through the first liquid crystal layer LC1 from the side of the first substrate S11 to the side of the second substrate S12, and is optically rotated by, for example, 90 degrees to transition to the P-wave. Since the polarization direction of the first polarized component PL1 is parallel to the long axis direction of the liquid crystal molecules LCM on the second electrode E12 side, it diffuses in the X-axis direction due to the influence of the arc-shaped refractive index distribution formed by the alignment of the liquid crystal molecules LCM. On the other hand, the second polarized component PL2 is in the P-wave, and since its polarization direction intersects with the long axis direction of the liquid crystal molecules LCM on the side of the first electrode E11, it passes through without being affected by the arc-shaped refractive index distribution formed by the alignment of the liquid crystal molecules LCM. The second polarized component PL2 is optically rotated, for example by 90 degrees, and transitions to the S-wave by passing through the first liquid crystal layer LC1 from the first substrate S11 side to the second substrate S12 side. Since the second polarized component PL2 is an S-wave, the polarization direction intersects the long axis direction of the liquid crystal molecules LCM on the second electrode E12 side and passes through without being affected by the arc-shaped refractive index distribution formed by the alignment of the liquid crystal molecules LCM.

Thus, when light is incident on the liquid crystal cell 10 shown in FIG. 14, the first polarized component PL1 (S-wave) is diffused once in each of the X-axis direction and the Y-axis direction, is optically rotated by the first liquid crystal layer LC1, and is transitioned to a P-wave, and is emitted, while the second polarized component PL2 (P-wave) is not diffused, is optically rotated by the first liquid crystal layer LC1, and is transitioned to an S-wave, and is emitted.

FIG. 14 shows a configuration in which electrodes for controlling the alignment state of liquid crystal molecules LCM are arranged on both the first substrate S11 and the second substrate S12, but the liquid crystal cell may have a configuration in which the electrodes are arranged on only one of the substrates. For example, the liquid crystal cell may have a configuration in which the electrodes are arranged on only the first substrate S11 or the second substrate S12.

The liquid crystal light control device 100 according to an embodiment of the present invention can distribute light emitted from a light source into various shapes by stacking three liquid crystal cells having the same configuration as the liquid crystal cell 10. More specifically, the following describes a typical example of the above-described liquid crystal cell 10, a liquid crystal cell from which some electrodes have been removed, a liquid crystal cell in which the typical example is rotated 90 degrees about the Z-axis, and a liquid crystal cell that combines these. These are described in detail below.

### First Embodiment

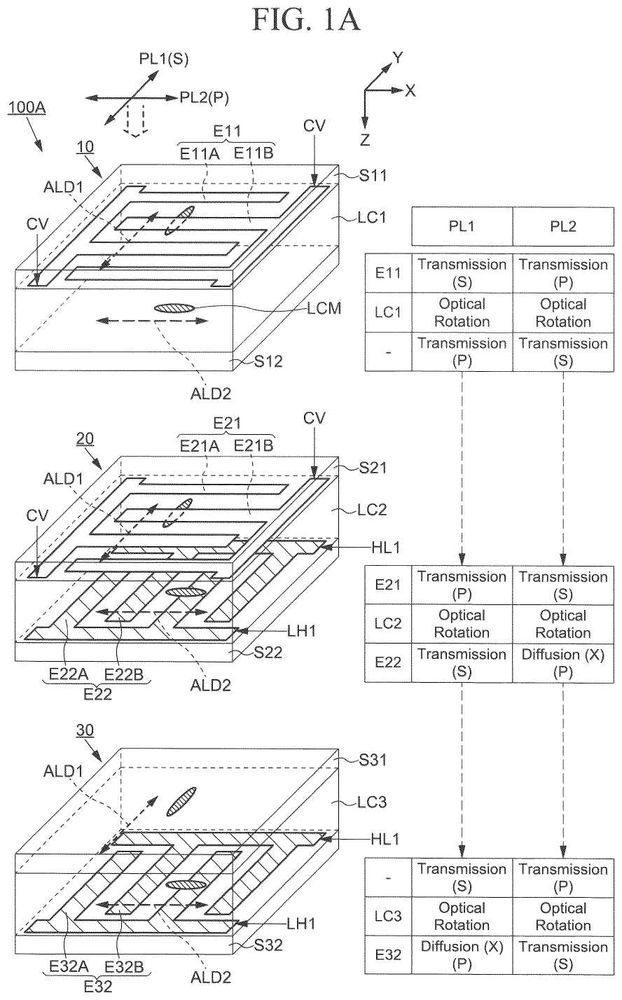

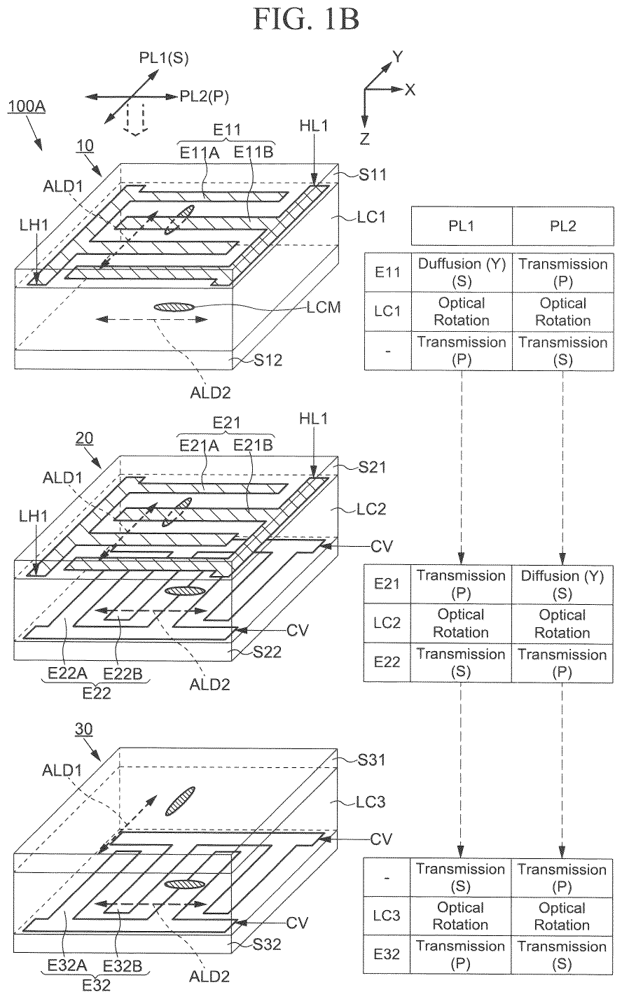

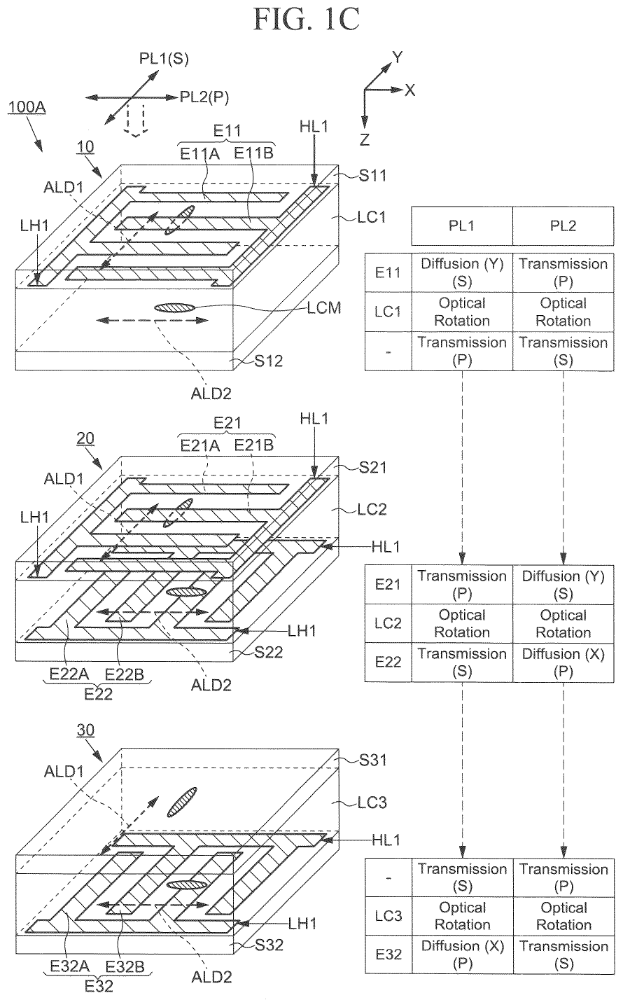

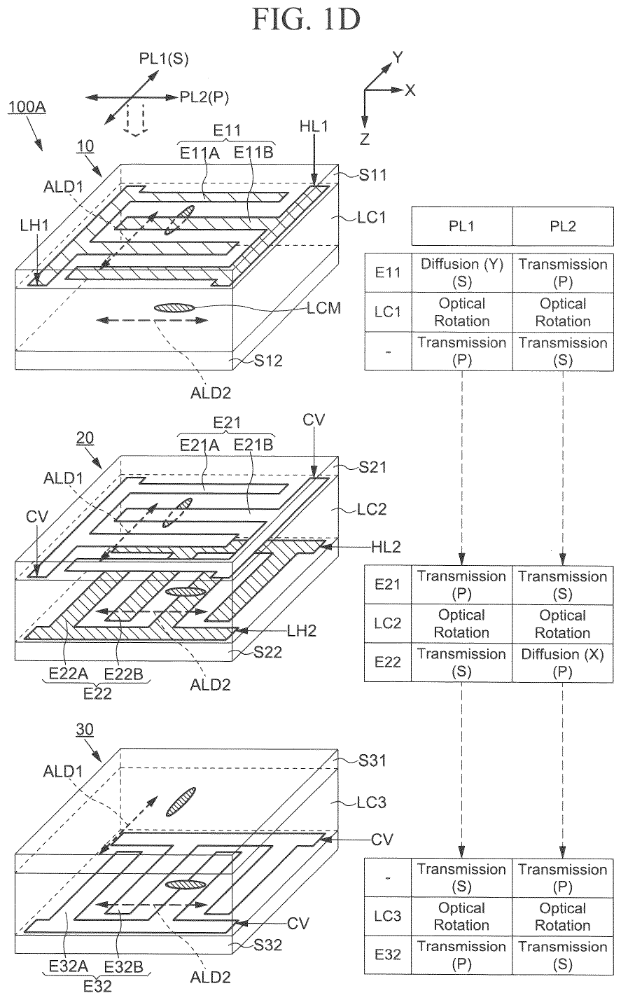

FIG. 1A shows a configuration of a liquid crystal light control device 100A according to the first embodiment. The liquid crystal light control device 100A has a structure in which the first liquid crystal cell 10, the second liquid crystal cell 20, and the third liquid crystal cell 30 are stacked in the Z-axis direction. Although the light source is not shown in FIG. 1A, light emitted from the light source passes through the first liquid crystal cell 10, the second liquid crystal cell 20, and the third liquid crystal cell 30 in that order and is emitted into the illumination space. The first liquid crystal cell 10, the second liquid crystal cell 20, and the third liquid crystal cell 30 each have a first substrate S11, S21, and S31 arranged on the light incident side, and a second substrate S12, S22, and S23 arranged on the light emitted side.

FIG. 1A shows, for explanation, each liquid crystal cell arranged separately, but the actual liquid crystal light control device 100A has a structure in which each liquid crystal cell is bonded with a light-transmissive adhesive. For simplicity, the alignment film is not shown in FIG. 1A. These notes apply to other drawings shown in this embodiment and other drawings shown in other embodiments.

The first liquid crystal cell 10 has the same configuration as the liquid crystal cell 10 shown in FIG. 14, except that a second electrode E12 is not arranged on the second substrate S12. The first liquid crystal cell 10 has a configuration in which a first electrode E11 is arranged only on the first substrate S11, and the second substrate S12 does not have an electrode for controlling the alignment state of liquid crystal molecules LCM. The first strip electrode E11A and the second strip electrode E11B that configure the first electrode E11 extend in the X-axis direction.

The second liquid crystal cell 20 has the same configuration as the liquid crystal cell 10 shown in FIG. 14, with a first electrode E21 arranged on the first substrate S21 and a second electrode E22 arranged on the second substrate S22, with a second liquid crystal layer LC2 interposed therebetween. A first strip electrode E21A and a second strip electrode E21B of the first electrode E21 extend in the X-axis direction, and a third strip electrode E22A and a fourth strip electrode E22B of the second electrode E22 extend in the Y-axis direction.

The third liquid crystal cell 30 has the same configuration as the liquid crystal cell 10 shown in FIG. 14, except that a second electrode 32 is arranged on the second substrate S32 and an electrode for controlling the alignment state of liquid crystal molecules LCM is not arranged on the first substrate S31. A third strip electrode E32A and a fourth strip electrode E32B of the second electrode E32 extend in the Y-axis direction.

The first liquid crystal cell 10 has the alignment film (not shown) arranged on the second substrate S12, and the alignment direction ALD2 of the alignment film is arranged to intersect (orthogonally) the alignment direction ALD1 of the alignment film on the side of the first substrate S11. The third liquid crystal cell 30 is arranged with an alignment film (not shown) on the first substrate S31, and its alignment direction ALD1 is arranged to intersect (orthogonally) the alignment direction ALD2 of the alignment film on the second substrate S32.

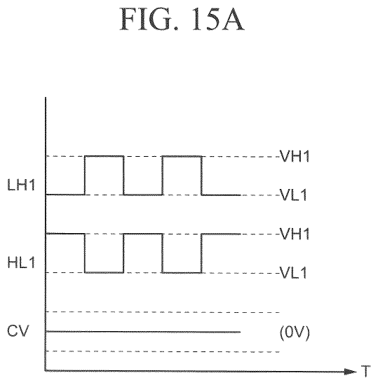

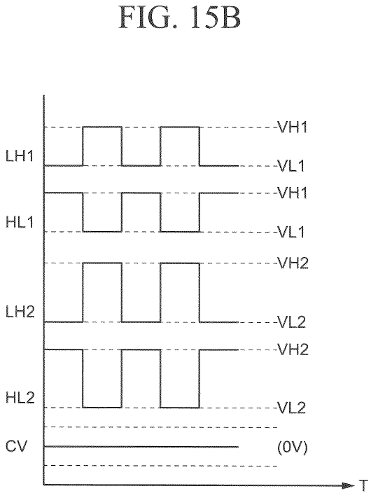

The first liquid crystal cell 10, the second liquid crystal cell 20, and the third liquid crystal cell 30 are driven by control signals LH1, HL1, and CV. FIG. 15A shows waveforms of control signals LH1, HL1, and CV. The control signal LH1 is a signal whose voltage level changes from VL1 to VH1 and from VH1 to VL1, and the control signal HL1 is a signal whose voltage level periodically changes from VH1 to VL1 and from VL1 to VH1. The low-level voltage VL1 is, for example, 0 V or −15 V, and the high-level voltage VH1 is, for example, 30 V (when VL1=0 V) or 15 V (when VL1=−15 V). The control signal LH1 and the control signal HL1 are synchronized, and when the control signal LH1 is at the VH1 level, the control signal HL1 is at the VL1 level, and when the control signal LH1 changes to the VL1 level, the control signal HL1 changes to the VH1 level. The period of control signals LH1 and HL1 is approximately 15 to 100 Hz. On the other hand, the control signal CV is a constant voltage signal, for example, a voltage signal at the midpoint between VL1 and VH1 or at 0 V.

FIG. 1A shows that in the first liquid crystal cell 10, the control signal CV is applied to the first strip electrode E11A and the second strip electrode E11B, and in the second liquid crystal cell 20, the control signal CV is applied to the first strip electrode E21A and the second strip electrode E21B, the control signal LH1 is applied to the third strip electrode E22A, the control signal HL1 is applied to the fourth strip electrode E22B, and in the third liquid crystal cell 30, the control signal LH1 is applied to the third strip electrode E32A, and the control signal HL1 is applied to the fourth strip electrode E32B.

As shown in the table inserted in FIG. 1A, the first polarized component PL1 (S-wave) of the light emitted from the light source is optically rotated by the first liquid crystal cell 10, the second liquid crystal cell 20, and the third liquid crystal cell 30, respectively, to be in the P-wave, and is diffused in the X-axis direction at the second electrode E32 of the third liquid crystal cell 30 and emitted. The second polarized component PL2 (P-wave) is optically rotated by the first liquid crystal cell 10 and the second liquid crystal cell 20 to be in the P-wave, diffused in the X-axis direction at the second electrode E22 of the second liquid crystal cell 20, optically rotated by the third liquid crystal cell 30, and emitted in the S-wave.

In this embodiment, focusing on the second liquid crystal cell 20, the first electrode E21 of the first substrate S21 and the second electrode E22 of the second substrate S22 are mutually orthogonal, which means that they rotate at an angle of substantially 90 degrees with respect to the above optical rotation. Here, when these electrodes intersect at an angle smaller than 90 degrees, the angle of optical rotation is smaller than 90 degrees. That is, the angle of the above-described “optical rotation” is determined based on the intersection angle of the first electrode E21 and the second electrode E22 and may include not only optical rotation at 90 degrees but also optical rotation at angles smaller than 90 degrees. In other words, the angle of the above-described “optical rotation” can be said to be determined based on the intersection angle between the alignment direction ALD1 of the alignment film on the first substrate E21 and the alignment direction ALD2 of the alignment film on the second substrate E22, and depending on the intersection angle between the alignment directions of the alignment films, optical rotation at an angle of 90 degrees is possible, as well as optical rotation at angles smaller than 90 degrees. The same applies to the first liquid crystal cell 10 and the third liquid crystal cell 30. The same applies to the other embodiments described below.

Therefore, the liquid crystal light control device 100A diffuses the light from the light source in the X-axis direction by diffusing each polarized component PL1 and PL2 once in the X-axis direction while rotating the first polarized component PL1 and the second polarized component PL2 according to the control signal application conditions shown in FIG. 1A. That is, the liquid crystal light control device 100A can spread the light distribution state of the light emitted from the light source in the X-axis direction. Such a light distribution pattern can be called line light distribution.

FIG. 1B shows that, in the first liquid crystal cell 10, the control signal LH1 is applied to the first strip electrode E11A and the control signal HL1 is applied to the second strip electrode E11B, in the second liquid crystal cell 20, a control signal LH1 is applied to the first strip electrode E21A, a control signal HL1 is applied to the second strip electrode E21B, and the control signal CV is applied to the third strip electrode E22A and the fourth strip electrode E22B, in the third liquid crystal cell 30, the control signal CV is applied to the third strip electrode E32A and the fourth strip electrode E32B.

As shown in the table inserted in FIG. 1B, the first polarized component PL1 (S-wave) of the light emitted from the light source is diffused in the Y-axis direction at the first electrode E11 of the first liquid crystal cell 10, and is optically rotated by the first liquid crystal cell 10, the second liquid crystal cell 20, and the third liquid crystal cell 30, respectively, and is emitted in the P-wave. The second polarized component PL2 (P-wave) is optically rotated in the first liquid crystal cell 10 to be in the S-wave, diffused in the Y-axis direction at the first electrode E21 of the second liquid crystal cell 20, optically rotated in the second liquid crystal cell 20 and the third liquid crystal cell 30, and emitted in the S-wave.

Therefore, the liquid crystal light control device 100A diffuses the light from the light source in the Y-axis direction by diffusing each polarized component PL1 and PL2 once in the Y-axis direction while rotating the first polarized component PL1 and the second polarized component PL2 according to the control signal application conditions shown in FIG. 1B. That is, the liquid crystal light control device 100A can spread the light distribution state of the light emitted from the light source in the Y-axis direction. Such a light distribution pattern can be called line light distribution, as in the case of FIG. 1A.

FIG. 1C shows that, in the first liquid crystal cell 10, the control signal LH1 is applied to the first strip electrode E11A and the control signal HL1 is applied to the second strip electrode E11B, in the second liquid crystal cell 20, the control signal LH1 is applied to the first strip electrode E21A, the control signal HL1 is applied to the second strip electrode E21B, the control signal LH1 is applied to the third strip electrode E22A, and the control signal HL1 is applied to the fourth strip electrode E22B, in the third liquid crystal cell, the control signal LH1 is applied to the third strip electrode E32A, and the control signal HL1 is applied to the fourth strip electrode E32B.

As shown in the table inserted in FIG. 1C, the first polarized component PL1 (S-wave) of the light emitted from the light source is diffused in the Y-axis direction at the first electrode E11 of the first liquid crystal cell 10, and is polarized in the X-axis direction by the first liquid crystal layer LC1, the second liquid crystal cell 20, and the third liquid crystal cell 30, respectively, to be in a P-wave, and is diffused in the X-axis direction at the second electrode E32 and emitted. The second polarized component PL2 (P-wave) is optically rotated in the first liquid crystal cell 10 to be in the S-wave, diffused in the Y-axis direction at the first electrode E21 of the second liquid crystal cell 20, optically rotated in the second liquid crystal layer LC2 to be in the P-wave, diffused in the X-axis direction at the second electrode E22, optically rotated in the third liquid crystal cell 30, and emitted in the S-wave.

Therefore, the liquid crystal light control device 100A diffuses each of the polarized components PL1 and PL2 once in the X-axis direction and once in the Y-axis direction while rotating the first polarized component PL1 and the second polarized component PL2 in accordance with the control signal application conditions shown in FIG. 1C. That is, the light distribution state of the light emitted from the light source can be expanded in the X-axis direction and the Y-axis direction, by diffusing at least one of the polarized components not only in one direction but in two directions that intersect each other (in this embodiment, the X-axis direction and the Y-axis direction). Such a light distribution pattern can be called circular light distribution.

FIG. 15B shows an example of control signals different from those shown in FIG. 15A. The control signals LH1 and HL1 are the same as those described with reference to FIG. 15A. The control signal LH2 is a signal whose voltage level changes from VL2 to VH2 and from VH2 to VL2, and the control signal HL2 is a signal whose voltage level periodically changes from VH2 to VL2 and from VL2 to VH2. The low-level voltage VI2 is, for example, 0 V or −30 V, and the high-level voltage Vh2 is, for example, 60 V (relative to VI2=0 V) or 30 V (relative to VI1=−30 V). The control signal LH2 and the control signal HL2 are synchronized, and when the control signal LH2 is at the VH2 level, the control signal HL2 is at the VL2 level, and when the control signal LH2 changes to the VL2 level, the control signal HL2 changes to the VH2 level. The period of the control signals LH2 and HL2 is the same as that of the control signals LH1 and HL1.

The use of these two levels of control signals makes it possible to change the circular light distribution in FIG. 1C to an elliptical light distribution. More specifically, the control signal LH1 is applied to the first strip electrode E11A of the first liquid crystal cell 10, the control signal HL1 is applied to the second strip electrode E11B, the control signal LH1 is applied to the first strip electrode E21A of the second liquid crystal cell 20, the control signal HL1 is applied to the second strip electrode E21B, at the same time, the control signal LH2 is applied to the third strip electrode E22A and the control signal HL2 is applied to the fourth strip electrode E22B, and the control signal LH2 is applied to the third strip electrode E32A of the third liquid crystal cell 30 and the control signal HL2 is applied to the fourth strip electrode E32B.

Thus, an elliptical light distribution in which the light distribution state (degree of diffusion) in the X-axis direction is larger than the light distribution state (degree of diffusion) in the Y-axis direction can be formed. As described above, it is possible to form an elliptical light distribution in which the light distribution in the Y-axis direction is larger than that in the X-axis direction by swapping the control signal LH1 and the control signal LH2 and also swapping the control signal HL1 and the control signal HL2.

FIG. 1D shows an example in which control signals of different voltage levels, as shown in FIG. 15B, are applied to the first liquid crystal cell 10 and the second liquid crystal cell 20. That is, the control signal LH1 is applied to the first strip electrode E11A of the first liquid crystal cell 10, the control signal HL1 is applied to the second strip electrode E11B, the control signal CV is applied to the first strip electrode E21A and the second strip electrode E21B of the second liquid crystal cell 20, the control signal LH2 is applied to the third strip electrode E22A, the control signal HL2 is applied to the fourth strip electrode E22B, and the control signal CV is applied to the third strip electrode E32A and the fourth strip electrode E32B of the third liquid crystal cell 30.

As shown in the table inserted in FIG. 1D, the first polarized component PL1 (S-wave) of the light emitted from the light source is diffused in the Y-axis direction at the first electrode E11 of the first liquid crystal cell 10, and is optically rotated by the first liquid crystal layer LC1, the second liquid crystal cell 20, and the third liquid crystal cell 30, respectively, and is emitted in the P-wave. The second polarized component PL2 (P-wave) is optically rotated by the second liquid crystal layer LC2 of the first liquid crystal cell 10 and the second liquid crystal cell 20, respectively, to be in the P-wave, diffused in the X-axis direction at the second electrode E22, and optically rotated by the third liquid crystal cell 30 to be emitted in the S-wave.

Therefore, the liquid crystal light control device 100A optically rotates the first polarized component PL1 and the second polarized component PL2 according to the control signal application conditions shown in FIG. 1D, and the first polarized component PL1 is diffused once in the Y-axis direction by the control signals LH1 and HL1, and the second polarized component PL2 is diffused once in the X-axis direction by the control signals LH2 and HL2, and then emitted. That is, the liquid crystal light control device 100A can distribute light emitted from the light source by diffusing the first polarized component PL1 only in the Y-axis direction and diffusing the second polarized component PL2 only in the X-axis direction. In this way, it is possible to form a cross-shaped light distribution pattern by controlling each polarized component to be diffused independently of each other in a specific direction. Such a light distribution pattern can be called a cross-light distribution. In this case, since the amplitudes of the control signals LH2 and HL2 applied to the second electrode E22 of the second liquid crystal cell 20 are larger than those of the control signals LH1 and HL21, diffusion in the X-axis direction is large (spreading is large). In other words, the liquid crystal light control device 100A can extend the light emitted from the light source in the X-axis direction relative to the Y-axis direction and distribute it. In other words, it is possible to change the spread of the cross (length in the X-axis direction and length in the Y-axis direction) when performing cross light distribution by changing the voltage level of the control signal. As shown in FIG. 1D, even if the control signals LH2 and HL2 applied to the second liquid crystal cell 20 are replaced with the control signals LH1 and HL1 applied to the first liquid crystal cell 10, the same cross light distribution can be achieved.

As described above, the liquid crystal light control device 100A according to the present embodiment can change the light emitted from the light source into various light distribution states by three liquid crystal cells. The liquid crystal light control device 100A according to the present embodiment is configured with three liquid crystal cells, thereby achieving a thin profile and, consequently, a compact lighting device.

### Second Embodiment

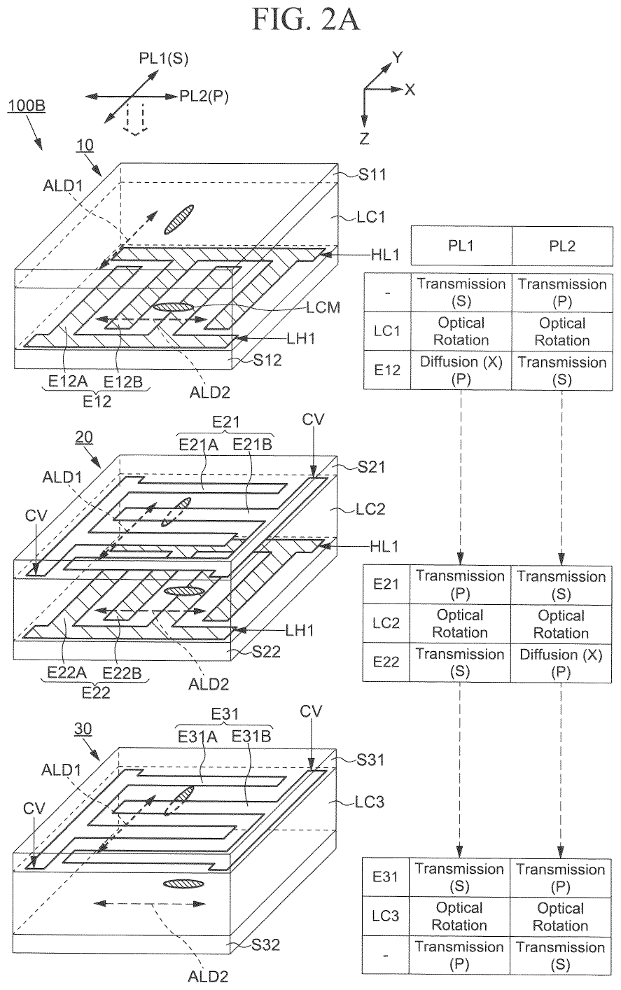

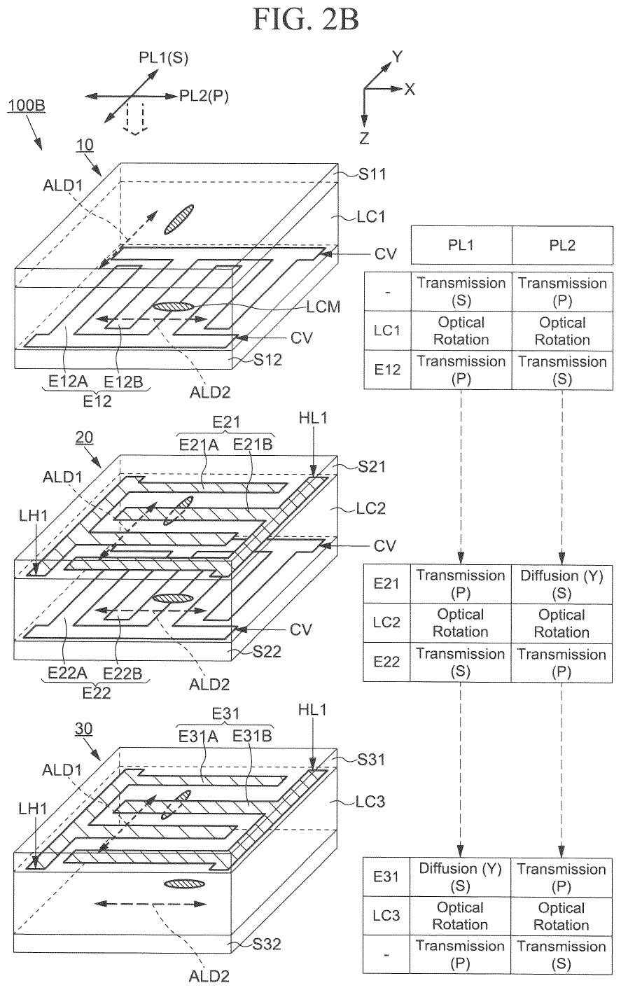

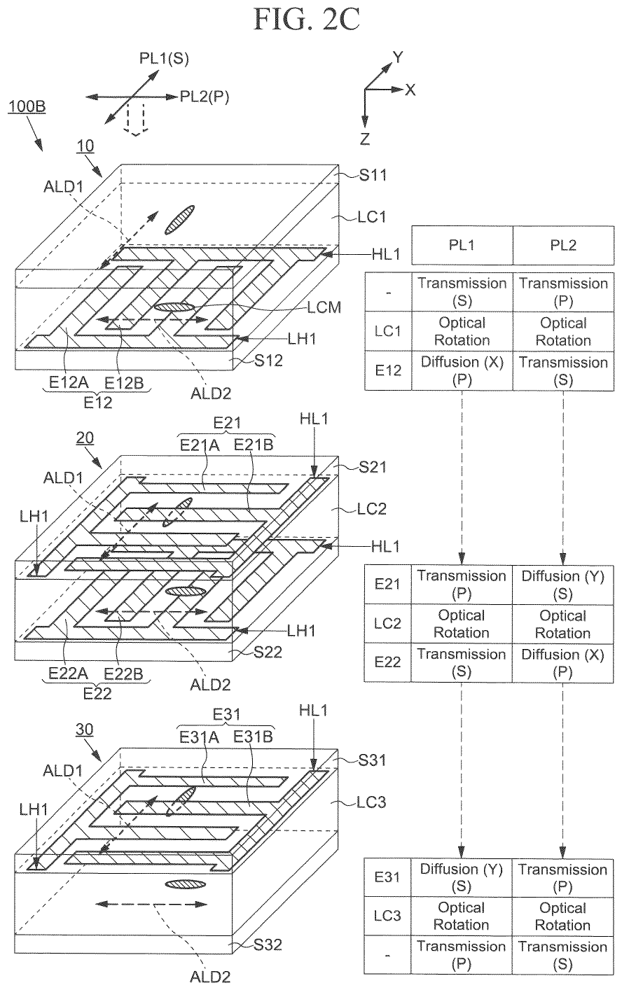

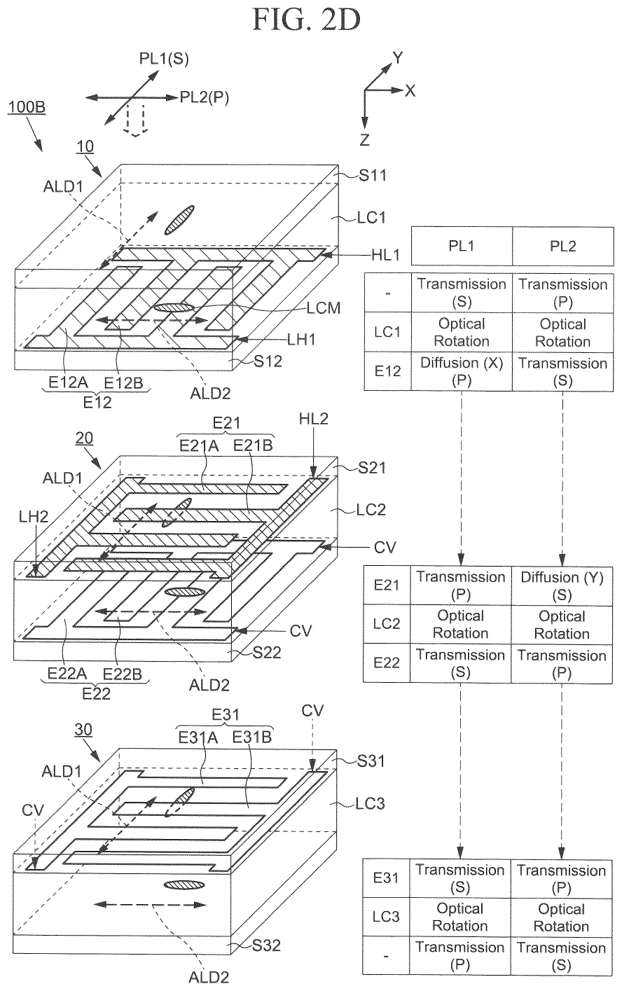

FIG. 2A shows the configuration of a liquid crystal light control device 100B according to the second embodiment. In contrast to the liquid crystal light control device 100A according to the first embodiment, the liquid crystal light control device 100B according to the present embodiment does not have an electrode arranged on the first substrate S11 of the first liquid crystal cell 10, and the second electrode E12 is arranged on the second substrate S12, the first electrode E31 is arranged on the first substrate S31 of the third liquid crystal cell 30, and an electrode is not arranged on the second substrate S32. As shown in FIG. 2A, the alignment film is also arranged on the first substrate S11 on which the electrodes are not arranged, and the alignment direction ALD1 of the alignment film intersects the alignment direction ALD2 of the alignment film on the second substrate S12 on which the electrodes are arranged within the same cell. The same applies to FIG. 2B to FIG. 2D.

FIG. 2A shows that, in the first liquid crystal cell 10, the control signal LH1 is applied to the third strip electrode E12A and the control signal HL1 is applied to the fourth strip electrode E12B, in the second liquid crystal cell 20, the control signal CV is applied to the first strip electrode E21A and the second strip electrode E21B, the control signal LH1 is applied to the third strip electrode E22A, and the control signal HL1 is applied to the fourth strip electrode E22B, in the third liquid crystal cell 30, the control signal CV is applied to the first strip electrode E31A and the second strip electrode E31B.

As shown in the table inserted in FIG. 2A, the first polarized component PL1 (S-wave) of the light emitted from the light source is optically rotated by the first liquid crystal layer LC1 of the first liquid crystal cell 10 to be in the P-wave, diffused in the X-axis direction by the second electrode E12, and optically rotated by the second liquid crystal cell 20 and the third liquid crystal cell 30 to be emitted in the P-wave. The second polarized component PL2 (P-wave) is optically rotated by the first liquid crystal cell 10, optically rotated by the second liquid crystal layer LC2 of the second liquid crystal cell 20 to be in the P-wave, diffused in the X-axis direction by the second electrode E22, optically rotated by the third liquid crystal cell 30, and emitted in the S-wave.

Therefore, the liquid crystal light control device 100B diffuses the light from the light source in the X-axis direction by diffusing each polarized component PL1 and PL2 once in the X-axis direction while optically rotating the first polarized component PL1 and the second polarized component PL2 according to the control signal application conditions shown in FIG. 2A. That is, the liquid crystal light control device 100B can spread the light distribution state of the light emitted from the light source in the X-axis direction (line light distribution).

FIG. 2B shows that, in the first liquid crystal cell 10, the control signal CV is applied to the third strip electrode E12A and the fourth strip electrode E12B, in the second liquid crystal cell 20, the control signal LH1 is applied to the first strip electrode E21A, the control signal HL1 is applied to the second strip electrode E21B, and the control signal CV is applied to the third strip electrode E22A and the fourth strip electrode E22B, in the third liquid crystal cell 30, the control signal LH1 is applied to the first strip electrode E31A, and the control signal HL1 is applied to the second strip electrode E31B.

As shown in the table inserted in FIG. 2B, the first polarized component PL1 (S-wave) of the light emitted from the light source is optically rotated by the first liquid crystal cell 10 and the second liquid crystal cell 20, respectively, to be in the S-wave, diffused in the Y-axis direction at the first electrode E31 of the third liquid crystal cell 30, optically rotated by the third liquid crystal layer LC3, and emitted in the P-wave. The second polarized component PL2 (P-wave) is optically rotated by the first liquid crystal cell 10 to be in the S-wave, diffused in the Y-axis direction at the first electrode E21 of the second liquid crystal cell 20, optically rotated by the second liquid crystal layer LC2, and further optically rotated by the third liquid crystal cell 30 to be in the S-wave and emitted.

Therefore, the liquid crystal light control device 100B diffuses the light from the light source in the Y-axis direction by diffusing each polarized component PL1 and PL2 once in the Y-axis direction while optically rotating the first polarized component PL1 and the second polarized component PL2 according to the control signal application conditions shown in FIG. 2B. That is, the liquid crystal light control device 100B can spread the light distribution state of the light emitted from the light source in the Y-axis direction (line light distribution).

FIG. 2C shows that, in the first liquid crystal cell 10, the control signal LH1 is applied to the third strip electrode E12A and the control signal HL1 is applied to the fourth strip electrode E12B, in the second liquid crystal cell 20, the control signal LH1 is applied to the first strip electrode E21A, the control signal HL1 is applied to the second strip electrode E21B, the control signal LH1 is applied to the third strip electrode E22A, and the control signal HL1 is applied to the fourth strip electrode E22B, in the third liquid crystal cell 30, the control signal LH1 is applied to the first strip electrode E31A, and the control signal HL1 is applied to the second strip electrode E31B.

As shown in the table inserted in FIG. 2C, the first polarized component PL1 (S-wave) of the light emitted from the light source is optically rotated by the first liquid crystal layer LC1 of the first liquid crystal cell 10 to be in the P-wave, diffused in the X-axis direction at the second electrode E12, optically rotated by the second liquid crystal cell 20 to be in the S-wave, diffused in the Y-axis direction at the first electrode E31 of the third liquid crystal cell 30, optically rotated by the third liquid crystal layer LC3 to be in the P-wave, and emitted. The second polarized component PL2 (P-wave) is optically rotated in the first liquid crystal cell 10 to be in the S-wave, diffused in the Y-axis direction at the first electrode E21 of the second liquid crystal cell 20, optically rotated in the second liquid crystal layer LC2 to be in the P-wave, diffused in the X-axis direction at the second electrode E22, optically rotated in the third liquid crystal cell 30, and emitted in the S-wave.

Therefore, the liquid crystal light control device 100B diffuses the polarized components PL1 and PL2 once in the X-axis direction and once in the Y-axis direction while optically rotating the first polarized component PL1 and the second polarized component PL2, thereby diffusing the light distribution state of the light from the light source as a whole in both the X-axis direction and the Y-axis direction (circular light distribution), according to the control signal application conditions shown in FIG. 2C.

FIG. 2D shows that in the first liquid crystal cell 10, the control signal LH1 is applied to the third strip electrode E12A and the control signal HL1 is applied to the fourth strip electrode E12B, in the second liquid crystal cell 20, the control signal LH2 is applied to the first strip electrode E21A, the control signal HL2 is applied to the second strip electrode E21B, and the control signal CV is applied to the third strip electrode E22A and the fourth strip electrode E22B, in the third liquid crystal cell 30, the control signal CV is applied to the third strip electrode E32A and the fourth strip electrode E32B.

As shown in the table inserted in FIG. 2D, the first polarized component PL1 (S-wave) of the light emitted from the light source is optically rotated by the first liquid crystal layer LC1 of the first liquid crystal cell 10 to be in the P-wave, diffused in the X-axis direction at the second electrode E12, and optically rotated by the second liquid crystal cell 20 and the third liquid crystal cell 30 to be emitted in the P-wave. The second polarized component PL2 (P-wave) is optically rotated by the first liquid crystal cell 10 to be in the S-wave, diffused in the Y-axis direction by the first electrode E21 of the second liquid crystal cell 20, optically rotated by the second liquid crystal layer LC2, and further optically rotated by the third liquid crystal cell 30 to be emitted in the S-wave.

Therefore, the liquid crystal light control device 100B, according to the control signal application conditions shown in FIG. 2D, optically rotates the first polarized component PL1 and the second polarized component PL2 while controlling the first polarized component PL1 with the control signal LH1 and the second polarized component PL2 with the control signal LH2 and the second polarized component PL2 is diffused in the Y-axis direction once by the control signals LH2 and HL2. That is, the liquid crystal light control device 100B can stretch the light emitted from the light source in the X-axis direction for the first polarized component PL1 and in the Y-axis direction for the second polarized component PL2 to achieve cross-polarized light distribution. In this case, since the amplitudes of the control signals LH2 and HL2 applied to the first electrode E21 of the second liquid crystal cell 20 are larger than those of the control signals LH1 and HL1, light distribution with large diffusion (large spread) in the Y-axis direction can be achieved. FIG. 2D, even if the control signals LH2 and HL2 applied to the second liquid crystal cell 20 are replaced with the control signals LH1 and HL1 applied to the first liquid crystal cell 10, a cross light distribution can be achieved in the same manner.

As described above, the liquid crystal light control device 100B according to the present embodiment can change the light emitted from the light source to various light distribution states by three liquid crystal cells. Since the liquid crystal light control device 100B according to the present embodiment is configured with three liquid crystal cells, it is thin and, thus, the lighting device can be miniaturized.

### Third Embodiment

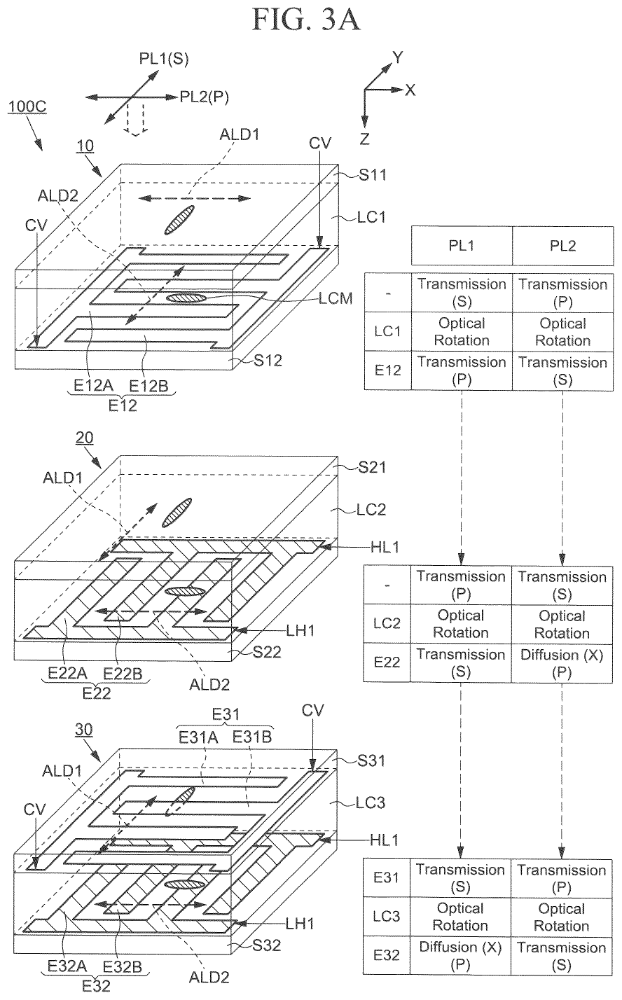

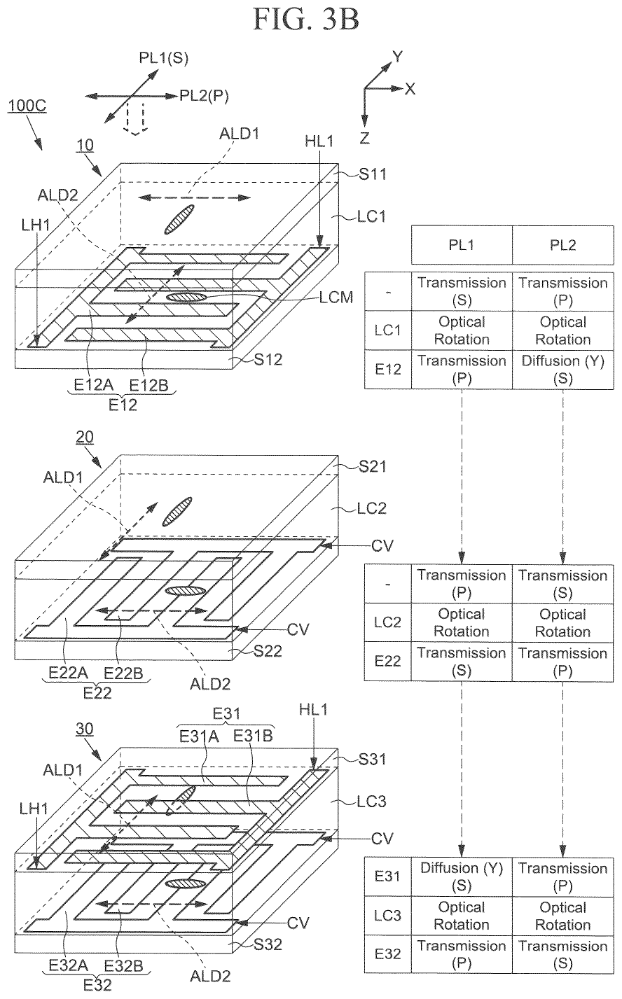

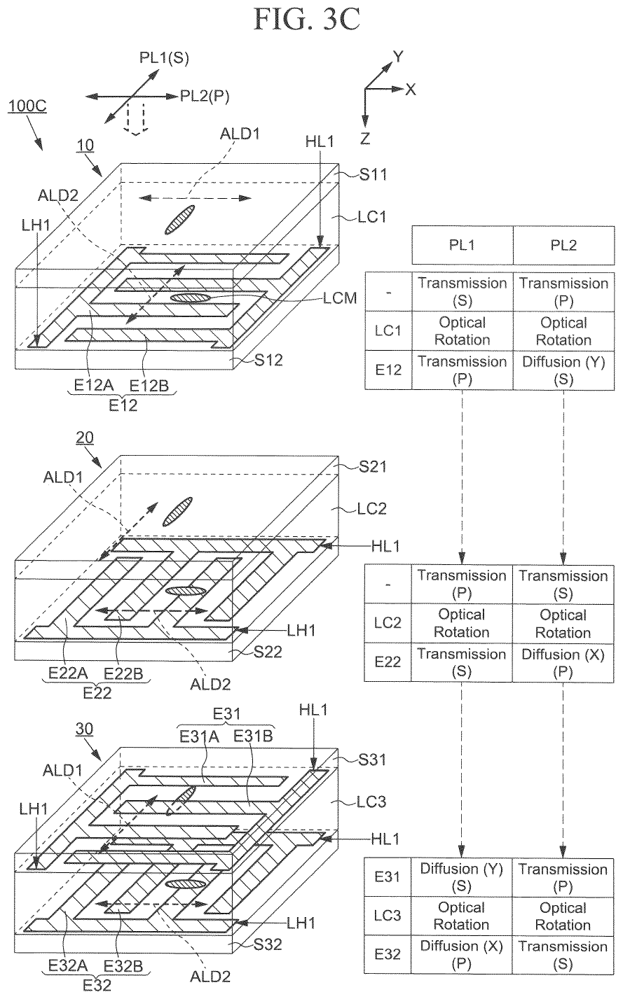

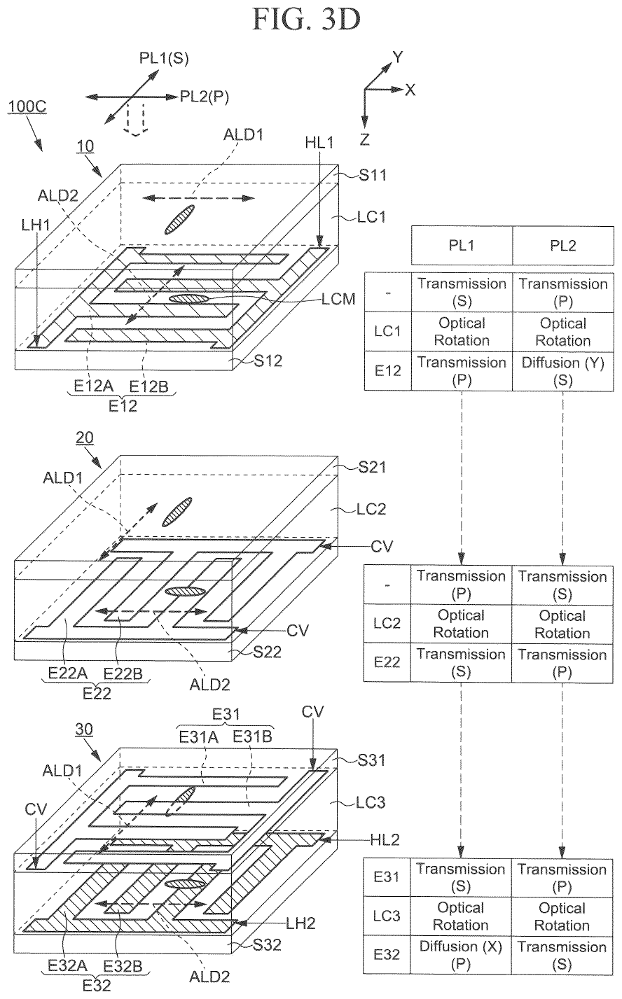

FIG. 3A shows the configuration of a liquid crystal light control device 100C according to the third embodiment. In contrast to the liquid crystal light control device 100A according to the first embodiment, the liquid crystal light control device 100C according to the present embodiment comprises the first liquid crystal cell 10, in which an electrode is not arranged on the first substrate S11 and the second electrode E12 is arranged on the second substrate S12, the second liquid crystal cell 20 is not arranged with an electrode on the first substrate S21 and the second electrode E22 is arranged on the second substrate S22, and the third liquid crystal cell 30 is arranged with the first electrode E31 on the first substrate S31 and the second electrode E32 on the second substrate S32. As indicated by the reference letters ALD in FIG. 3A, the alignment film is also arranged on the substrate without electrodes, and the alignment direction of the alignment film is crossed with the alignment direction of the alignment film on the substrate on which the electrodes are arranged within the same cell. The same applies to FIG. 3B to FIG. 3D.

FIG. 3A shows that the control signal CV is applied to the third strip electrode E12A and the fourth strip electrode E12B of the first liquid crystal cell 10, the control signal LH1 is applied to the third strip electrode E22A of the second liquid crystal cell 20, and the control signal HL1 is applied to the fourth strip electrode E22B, the control signal CV is applied to the first strip electrode E31A and the second strip electrode E31B of the third liquid crystal cell 30, the control signal LH1 is applied to the third strip electrode E32A, and the control signal HL1 is applied to the fourth strip electrode E32B.

As shown in the table inserted in FIG. 3A, the first polarized component PL1 (S-wave) of the light emitted from the light source is optically rotated by the first liquid crystal cell 10 and the second liquid crystal cell 20, respectively, to be in the S-wave, optically rotated by the third liquid crystal cell 30 to be in the P-wave, and diffused in the X-axis direction by the second electrode E32 and emitted. The second polarized component PL2 (P-wave) is optically rotated by the first liquid crystal cell 10 and the second liquid crystal cell 20 to be in the P-wave, diffused in the X-axis direction by the second electrode E22, optically rotated by the third liquid crystal cell 30, and emitted in the S-wave.

Therefore, the liquid crystal light control device 100C diffuses the first polarized component PL1 and the second polarized component PL2 once in the X-axis direction by rotating the optical rotation of the first polarized component PL1 and the second polarized component PL2 according to the control signal application conditions shown in FIG. 3A, thereby diffusing and emitting the light from the light source in the X-axis direction as a whole. That is, the liquid crystal light control device 100C can spread the light distribution state of the light emitted from the light source in the X-axis direction (line light distribution).

FIG. 3B shows that the control signal LH1 is applied to the third strip electrode E12A of the first liquid crystal cell 10, the control signal HL1 is applied to the fourth strip electrode E12B, the control signal CV is applied to the third strip electrode E22A and the fourth strip electrode E22B of the second liquid crystal cell 20, the control signal LH1 is applied to the first strip electrode E31A of the third liquid crystal cell 30, the control signal HL1 is applied to the second strip electrode E31B, and the control signal CV is applied to the third strip electrode E32A and the fourth strip electrode E32B.

As shown in the table inserted in FIG. 3B, the first polarized component PL1 (S-wave) of the light emitted from the light source is optically rotated by the first liquid crystal cell 10 and the second liquid crystal cell 20, respectively, to be in the S-wave, diffused in the Y-axis direction at the first electrode E31 of the third liquid crystal cell 30, optically rotated by the third liquid crystal layer LC3, and emitted in the P-wave. The second polarized component PL2 (P-wave) is optically rotated by the first liquid crystal layer LC1 of the first liquid crystal cell 10 to be in the S-wave, diffused in the Y-axis direction at the second electrode E12, optically rotated by the second liquid crystal cell 20 and the third liquid crystal cell 30, respectively, to be in the S-wave, and emitted.

Therefore, the liquid crystal light control device 100C diffuses the light from the light source in the Y-axis direction as a whole by diffusing each polarized component PL1 and PL2 once in the Y-axis direction while optically rotating the first polarized component PL1 and the second polarized component PL2 according to the control signal application conditions shown in FIG. 3B. That is, the liquid crystal light control device 100C can spread the light distribution of the light emitted from the light source in the Y-axis direction (line light distribution).

FIG. 3C shows that the control signal LH1 is applied to the third strip electrode E12A of the first liquid crystal cell 10, the control signal HL1 is applied to the fourth strip electrode E12B, the control signal LH1 is applied to the third strip electrode E22A of the second liquid crystal cell 20, the control signal HL1 is applied to the fourth strip electrode E22B, the control signal LH1 is applied to the first strip electrode E31A of the third liquid crystal cell 30, the control signal HL1 is applied to the second strip electrode E31B, the control signal LH1 is applied to the third strip electrode E32A, and the control signal HL1 is applied to the fourth strip electrode E32B.

As shown in the table inserted in FIG. 3C, the first polarized component PL1 (S-wave) of the light emitted from the light source is optically rotated by the first liquid crystal cell 10 and the second liquid crystal cell 20 to be in the S-wave, diffused in the Y-axis direction at the first electrode E31 of the third liquid crystal cell 30, optically rotated by the third liquid crystal layer LC3 to be in the P-wave, and diffused in the X-axis direction at the second electrode E32 and emitted. The second polarized component PL2 (P-wave) is optically rotated by the first liquid crystal layer LC1 of the first liquid crystal cell 10 to be in the S-wave, diffused in the Y-axis direction at the second electrode E12, optically rotated by the second liquid crystal layer LC2 of the second liquid crystal cell 20 to be in the P-wave, diffused in the X-axis direction at the second electrode E22, optically rotated by the third liquid crystal cell 30, and emitted in the S-wave.

Therefore, the liquid crystal light control device 100C can diffuse each polarized component PL1 and PL2 in the X-axis direction and the Y-axis direction once while rotating the first polarized component PL1 and the second polarized component PL2 in accordance with the control signal application conditions shown in FIG. 3C, thereby diffusing the light emitted from the light source as a whole in the X-axis direction and the Y-axis direction (circular light distribution).

FIG. 3D shows that the control signal LH1 is applied to the third strip electrode E12A of the first liquid crystal cell 10, the control signal HL1 is applied to the fourth strip electrode E12B, the control signal CV is applied to the third strip electrode E22A and the fourth strip electrode E22B of the second liquid crystal cell 20, the control signal CV is applied to the first strip electrode E31A and the second strip electrode E31B of the third liquid crystal cell 30, the control signal LH2 is applied to the third strip electrode E32A, and the control signal HL2 is applied to the fourth strip electrode E32B.

As shown in the table inserted in FIG. 3D, the first polarized component PL1 (S-wave) of the light emitted from the light source is optically rotated by the first liquid crystal cell 10 and the second liquid crystal cell 20 to be in the S-wave, optically rotated by the third liquid crystal layer LC3 of the third liquid crystal cell 30 to be in the P-wave, and diffused in the X-axis direction by the second electrode E32 and emitted. The second polarized component PL2 (P-wave) is optically rotated by the first liquid crystal layer LC1 of the first liquid crystal cell 10 to be in the S-wave, diffused in the Y-axis direction at the second electrode E12, optically rotated by the second liquid crystal cell 20 and the third liquid crystal cell 30, respectively, and emitted in the S-wave.

Therefore, the liquid crystal light control device 100C, according to the control signal application conditions shown in FIG. 3D, optically rotates the first polarized component PL1 and the second polarized component PL2, and the first polarized component PL1 is diffused once in the X-axis direction by the control signals LH2 and HL2, and the second polarized component PL2 is diffused once in the Y-axis direction by the control signals LH1 and HL1. That is, the liquid crystal light control device 100C can stretch the light emitted from the light source in the X-axis direction for the first polarized component PL1 and in the Y-axis direction for the second polarized component PL2 to achieve a cross-directional light distribution. In this case, since the amplitudes of the control signals LH2 and HL2 applied to the second electrode E32 of the third liquid crystal cell 30 are larger than those of the control signals LH1 and HL1, a light distribution with large diffusion (large spread) in the X-axis direction can be achieved. In FIG. 3D, even if the control signals LH2 and HL2 applied to the third liquid crystal cell 30 are replaced with the control signals LH1 and HL1 applied to the first liquid crystal cell 10, a cross light distribution can be achieved in the same manner.

As described above, the liquid crystal light control device 100C according to the present embodiment can change the light emitted from the light source into various light distribution states by using three liquid crystal cells. Since the liquid crystal light control device 100C according to the present embodiment is configured with three liquid crystal cells, it is possible to make it thin and, consequently, to make the lighting device compact.

### Fourth Embodiment

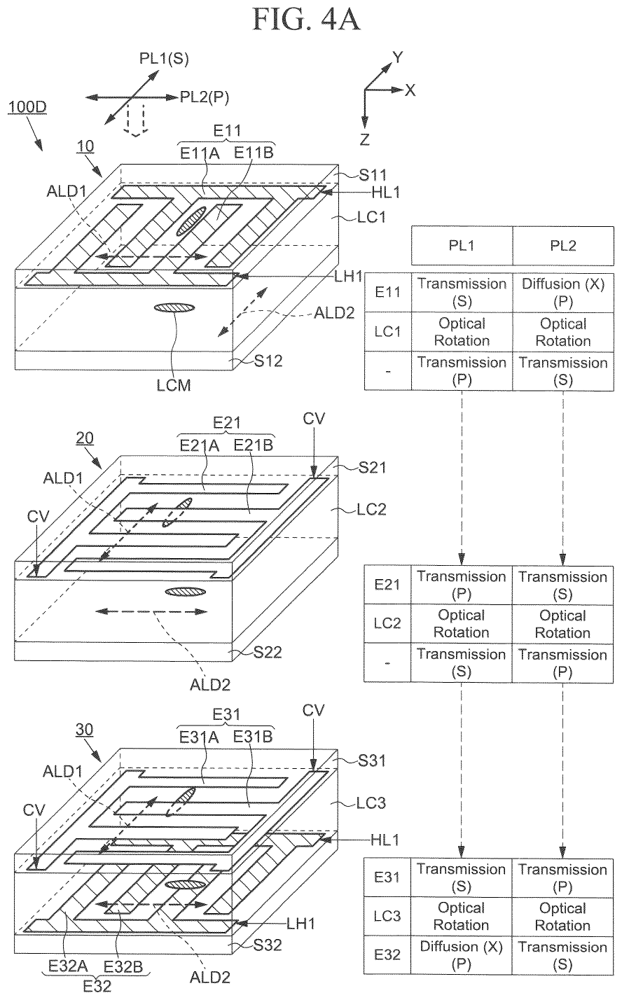

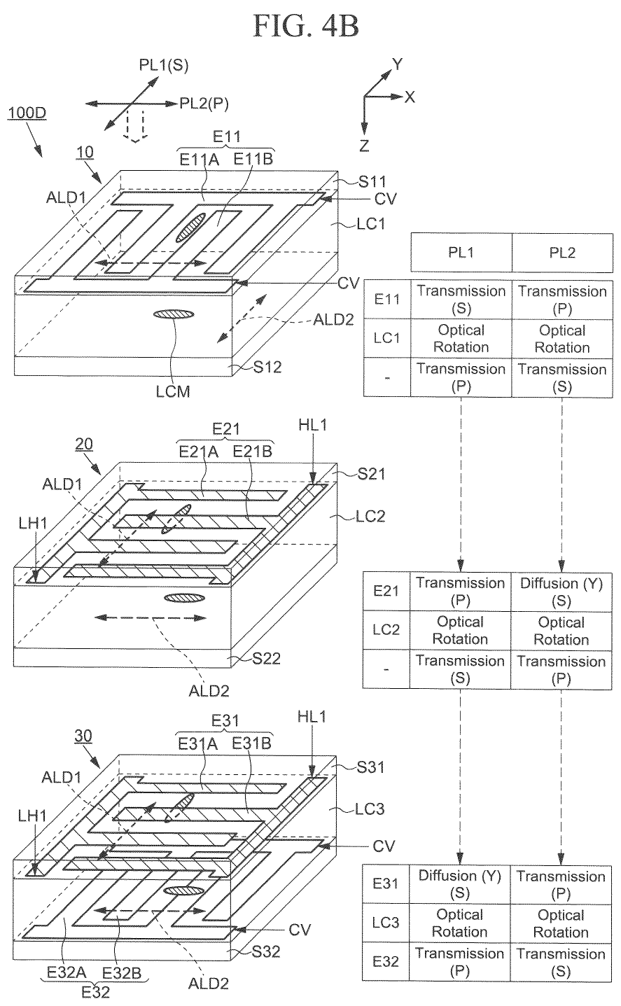

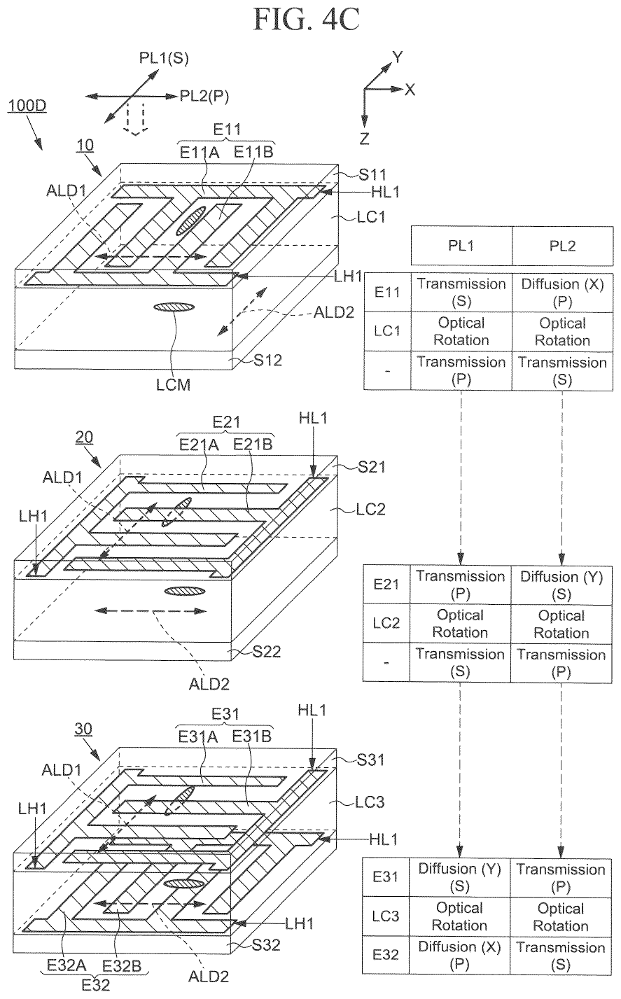

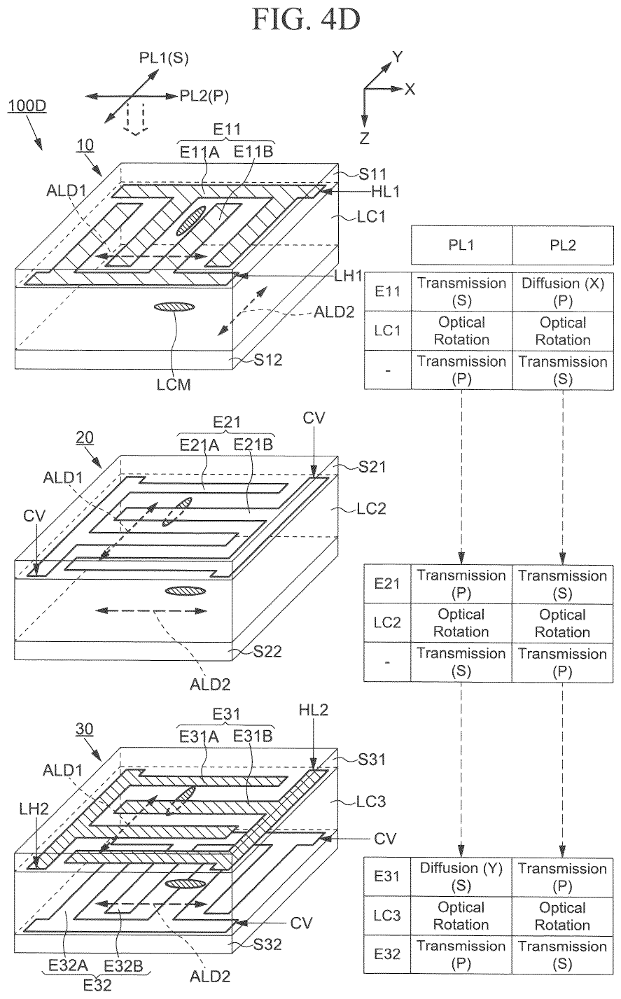

FIG. 4A shows the configuration of a liquid crystal light control device 100D according to the fourth embodiment. In contrast to the liquid crystal light control device 100C according to the third embodiment, the liquid crystal light control device 100D according to the present embodiment includes, the first liquid crystal cell 10, in which the first electrode E11 is arranged on the first substrate S11 and an electrode is not arranged on the second substrate S12, the second liquid crystal cell 20 includes the first electrode E21 arranged on the side of the second substrate S21 and an electrode arranged on the side of the second substrate S22. The third liquid crystal cell 30 has the same configuration as in the third embodiment.

FIG. 4A shows that the control signal LH1 is applied to the first strip electrode E11A of the first liquid crystal cell 10, the control signal HL1 is applied to the second strip electrode E11B, the control signal CV is applied to the first strip electrode E21A and the second strip electrode E21B of the second liquid crystal cell 20, the control signal CV is applied to the first strip electrode E31A and the second strip electrode E31B of the third liquid crystal cell 30, the control signal LH1 is applied to the third strip electrode E32A, and the control signal HL1 is applied to the fourth strip electrode E32B.

As shown in the table inserted in FIG. 4A, the first polarized component PL1 (S-wave) of the light emitted from the light source is optically rotated by the first liquid crystal cell 10 and the second liquid crystal cell 20 to be in the S-wave, optically rotated by the third liquid crystal layer LC3 of the third liquid crystal cell 30 to be in the P-wave, and diffused in the X-axis direction by the second electrode E32 and emitted. The second polarized component PL2 (P-wave) is diffused in the X-axis direction at the first electrode E11 of the first liquid crystal cell 10, optically rotated by the first liquid crystal layer LC1 to be in the S-wave, optically rotated by the second liquid crystal cell 20 and the third liquid crystal cell 30, respectively, and emitted in the S-wave.

Therefore, the liquid crystal light control device 100D diffuses the light from the light source in the X-axis direction as a whole by diffusing each polarized component PL1 and PL2 once in the X-axis direction while optically rotating the first polarized component PL1 and the second polarized component PL2 according to the control signal application conditions shown in FIG. 4A. That is, the liquid crystal light control device 100D can spread the alignment state of the light emitted from the light source in the X-axis direction and distribute the light (line distribution).

FIG. 4B shows that the control signal CV is applied to the first strip electrode E11A and the second strip electrode E11B of the first liquid crystal cell 10, the control signal LH1 is applied to the first strip electrode E21A of the second liquid crystal cell 20, and the control signal HL1 is applied to the second strip electrode E21B, the control signal LH1 is applied to the first strip electrode E31A of the third liquid crystal cell 30, the control signal HL1 is applied to the second strip electrode E31B, and the control signal CV is applied to the third strip electrode E32A and the fourth strip electrode E32B.

As shown in the table inserted in FIG. 4B, the first polarized component PL1 (S-wave) of the light emitted from the light source is optically rotated by the first liquid crystal cell 10 and the second liquid crystal cell 20, respectively, to be in the S-wave, diffused in the Y-axis direction at the first electrode E31 of the third liquid crystal cell 30, optically rotated by the third liquid crystal layer LC3, and emitted in the P-wave. The second polarized component PL2 (P-wave) is optically rotated by the first liquid crystal cell 10 to be in the S-wave, diffused in the Y-axis direction at the first electrode E21 of the second liquid crystal cell 20, optically rotated by the second liquid crystal layer LC2 to be in the P-wave, optically rotated by the third liquid crystal cell 30 to be in the S-wave, and emitted.

Therefore, the liquid crystal light control device 100D diffuses the light from the light source in the Y-axis direction as a whole by diffusing each polarized component PL1 and PL2 once in the Y-axis direction while optically rotating the first polarized component PL1 and the second polarized component PL2 according to the control signal application conditions shown in FIG. 4B. That is, the liquid crystal light control device 100D can spread the light distribution state of the light emitted from the light source in the Y-axis direction (line light distribution).

FIG. 4C shows that a control signal LH1 is applied to the first strip electrode E11A of the first liquid crystal cell 10, the control signal HL1 is applied to the second strip electrode E11B, the control signal LH1 is applied to the first strip electrode E21A of the second liquid crystal cell 20, the control signal HL1 is applied to the second strip electrode E21B, the control signal LH1 is applied to the first strip electrode E31A of the third liquid crystal cell 30, the control signal HL1 is applied to the second strip electrode E31B, the control signal LH1 is applied to the third strip electrode E32A, and the control signal HL1 is applied to the fourth strip electrode E32B.

As shown in the table inserted in FIG. 4C, the first polarized component PL1 (S-wave) of the light emitted from the light source is optically rotated by the first liquid crystal cell 10 and the second liquid crystal cell 20 to be in the S-wave, diffused in the Y-axis direction at the first electrode E31 of the third liquid crystal cell 30, optically rotated by the third liquid crystal layer LC3 to be in the P-wave, and diffused in the X-axis direction at the second electrode E32 and emitted. The second polarized component PL2 (P-wave) is diffused in the X-axis direction at the first electrode E11 of the first liquid crystal cell 10, optically rotated by the first liquid crystal layer LC1 to be in the S-wave, diffused in the Y-axis direction at the first electrode E21 of the second liquid crystal cell 20, optically rotated by the second liquid crystal layer LC2 to be in the P-wave, optically rotated by the third liquid crystal cell 30, and emitted in the S-wave.

Therefore, the liquid crystal light control element 100D diffuses the polarization components PL1 and PL2 once in the X-axis direction and the Y-axis direction while rotating the first polarization component PL1 and the second polarization component PL2 according to the application conditions of the control signal shown in FIG. 4C, thereby expanding the light distribution state of the light emitted from the light source as a whole in the X-axis direction and the Y-axis direction and emitting the light. That is, the liquid crystal light control device 100D can expand the light distribution state of the light emitted from the light source in the X-axis direction and the Y-axis direction (circular light distribution).

FIG. 4D shows that the control signal LH1 is applied to the first strip electrode E11A of the first liquid crystal cell 10, the control signal HL1 is applied to the second strip electrode E11B, the control signal CV is applied to the first strip electrode E21A and the second strip electrode E21B of the second liquid crystal cell 20, the control signal LH2 is applied to the first strip electrode E31A of the third liquid crystal cell 30, the control signal HL2 is applied to the second strip electrode E31B, and the control signal CV is applied to the third strip electrode E32A and the fourth strip electrode E32B.

As shown in the table inserted in FIG. 4D, the first polarized component PL1 (S-wave) of the light emitted from the light source is optically rotated by the first liquid crystal cell 10 and the second liquid crystal cell 20, respectively, to be in the S-wave, diffused in the Y-axis direction at the first electrode E31 of the third liquid crystal cell 30, optically rotated by the third liquid crystal layer LC3, and emitted in the P-wave. The second polarized component PL2 (P-wave) is diffused in the X-axis direction at the first electrode E11 of the first liquid crystal cell 10, optically rotated by the first liquid crystal layer LC1 to be in the S-wave, optically rotated by the second liquid crystal cell 20 and the third liquid crystal cell 30, respectively, and emitted in the S-wave.

Therefore, the liquid crystal light control device 100D, according to the control signal application conditions shown in FIG. 4D, optically rotates the first polarized component PL1 and the second polarized component PL2, and the first polarized component PL1 is diffused once in the Y-axis direction by the control signals LH2 and HL2, and the second polarized component PL2 is diffused once in the X-axis direction by the control signals LH1 and HL1 in the X-axis direction once, and then emits the light. That is, the liquid crystal light control device 100D can stretch the light emitted from the light source in the Y-axis direction for the first polarized component PL1 and in the X-axis direction for the second polarized component PL2, thereby enabling cross light distribution. The first polarized component PL1 is diffused once in the Y-axis direction while undergoing optical rotation, and the second polarized component PL2 is diffused once in the X-axis direction while undergoing optical rotation. In this case, since the amplitudes of the control signals LH2 and HL2 applied to the first electrode E31 of the third liquid crystal cell 30 are larger than those of the control signals LH1 and HL1, a light distribution with large diffusion (large spread) in the Y-axis direction can be achieved. FIG. 4D, even if the control signals LH2 and HL2 applied to the third liquid crystal cell 30 are replaced with the control signals LH1 and HL1 applied to the first liquid crystal cell 10, a cross light distribution can be achieved in the same manner.

As described above, the liquid crystal light control device 100D according to the present embodiment can change the light emitted from the light source to various light distribution states by three liquid crystal cells. Since the liquid crystal light control device 100D according to the present embodiment is configured with three liquid crystal cells, it is thin and, as a result, the lighting device can be miniaturized.

### Fifth Embodiment

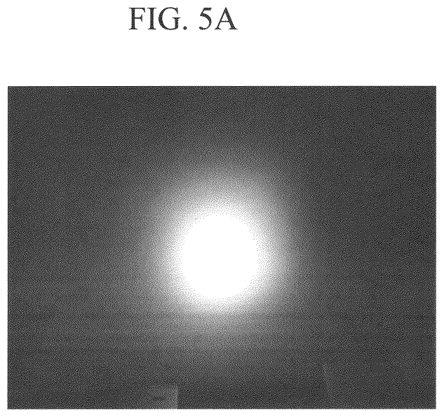

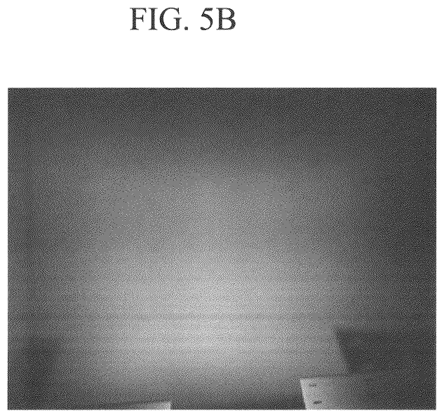

This embodiment shows the light distribution characteristics of the liquid crystal light control device 100B shown in the second embodiment. FIG. 5A is a photograph of the projection plane of the illumination light when the control signals are not applied to the liquid crystal light control device 100B, and FIG. 5B is a photograph of the projection plane when the control signals LH1 and HL1 are applied to all electrodes of each liquid crystal cell as described with reference to FIG. 2C. The cell gap and electrode spacing of the liquid crystal light control device 100B used for measurement are shown in Table 1. The control signals LH1 and HL1 for driving the liquid crystal light control device 100B are VH1=15 V and VL1=−15 V (refer to FIG. 15A).

TABLE 1

| | Cell Gap | Width/Pich of Electrode |
|---|---|---|
| 1st liquid crystal cell (10) | 30 μm | 8 μm/8 μm |
| 2nd liquid crystal cell (20) | | |
| 3rd liquid crystal cell (30) | | |

| | |
|---|---|
| Light Distribution Angle | 52 degrees |

As shown in FIG. 5A, when the control signal is not applied to the liquid crystal light control device 100B, the distribution of the intensity of the illumination light reflects the distribution of the light intensity of the light source. On the other hand, as shown in FIG. 5B, when the control signals LH1 and HL1 are applied, the illumination light is diffused in the vertical and horizontal directions.

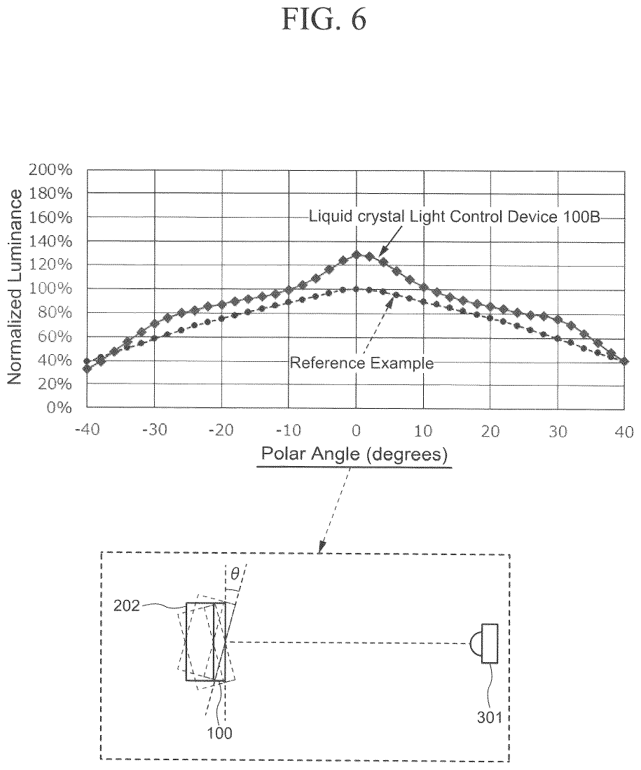

FIG. 6 shows the brightness versus angle characteristics of the liquid crystal light control device 100B. The horizontal axis of the graph in FIG. 6 indicates the polar angle, and the vertical axis indicates the brightness. The graph in FIG. 6 shows the characteristics of the liquid crystal light control device 100B and, as a reference example, the characteristics of the liquid crystal light control device configured with four liquid crystal cells. The brightness values shown on the vertical axis of the graph are normalized values, where the brightness at a polar angle of 0 degrees for the reference example is set to 100.

The “polar angle” refers to the angle between the normal direction of the main surface of the liquid crystal light control device and the direction of propagation of the emitted light. As shown in the inset of FIG. 6, the measurement was performed while rotating the liquid crystal light control device 100 and the light source 202 relative to the detector 301. As shown in the figure, the angle θ by which the main surface of the liquid crystal light control device 100 is tilted relative to the state in which the main surface of the liquid crystal light control device 100 is facing the detector 301 (the state in which the detector 301 is arranged in the normal direction of the main surface of the liquid crystal light control device 100) corresponds to the polar angle. That is, when the main surface of the liquid crystal light control device 100 is facing the detector 301, the polar angle is 0 degrees, and the polar angle θ increases as the liquid crystal light control device 100 is tilted. Then, when the liquid crystal light control device 100 is facing the detector 301 (polar angle 0 degrees), the brightness is the front brightness, and by investigating how the brightness changes when the polar angle is changed, the light distribution characteristics of the liquid crystal light control device 100 can be known. Therefore, the smaller the change in brightness with respect to the change in the polar angle, the wider the angle at which the light emitted from the light source 202 can be distributed.

As shown in the graph of FIG. 6, the brightness of the liquid crystal light control device 100B is generally higher than that of the device of the reference example (the device having four liquid crystal cells). The light distribution angle of the device of the reference example (the device with four liquid crystal cells) is 53 degrees, while the light distribution angle of the liquid crystal light control device 100B is 52 degrees, which is equivalent to the light distribution angle of the device of the reference example. The light distribution angle is the angle (polar angle) at which the brightness is ½ of the brightness when the polar angle is 0 degrees.

This result shows that brightness can be increased by reducing the number of liquid crystal cells by one, and that a wide light distribution angle can be maintained by using an electrode configuration such as the liquid crystal light control device 100B. Furthermore, it is possible to miniaturize the lighting device without deteriorating the light distribution characteristics by using such a liquid crystal light control device.

### Sixth Embodiment

This embodiment shows the light distribution characteristics when the cell gap of the liquid crystal cell is changed in the liquid crystal light control device 100B shown in the second embodiment. The cell gaps of the liquid crystal light control device 100B used for measurement are shown in Table 2. The cell gaps of the first liquid crystal cell 10 and the third liquid crystal cell 30 are 15 μm, while the cell gap of the second liquid crystal cell 20 is 55 μm. That is, the first liquid crystal cell 10 and the third liquid crystal cell 30 are arranged with electrodes on one of the first substrate S11, S31 and the second substrate S12, S32, and the second liquid crystal cell 20 is arranged with electrodes on both the first substrate S21 and the second substrate S22, and the cell gap D2 of the second liquid crystal cell 20 is larger than the cell gap D1 of the first liquid crystal cell 10 and the third liquid crystal cell 30 (D2>D1). In this embodiment, the cell gap has a relationship of D2>3×D1, but the cell gap relationship may be at least D2>D1, D2>2×D1 is more preferable, and D2>3×D1 is even more preferable. On the other hand, since there is a natural limit to the cell gap in order to stably control the liquid crystal molecules, it is preferable that D2≤100 μm, and based on this point, it is more preferable that D2≤6×D1. The control signals LH1 and HL1 for driving the liquid crystal light control device 100B are VH1=15 V and VL1=−15 V.

TABLE 2

| | Cell Gap | Width/Pich of Electrode |
|---|---|---|
| 1st liquid crystal cell (10) | 15 μm | 8 μm/8 μm |
| 2nd liquid crystal cell (20) | 30 μm | |
| 3rd liquid crystal cell (30) | 15 μm | |

| | |
|---|---|
| Light Distribution Angle | 52 degrees |

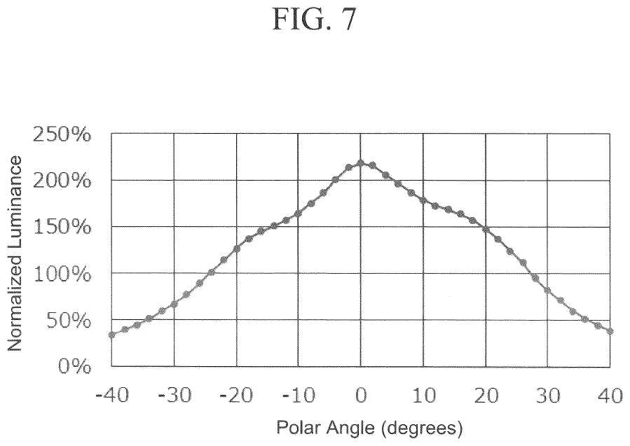

FIG. 7 shows the brightness-angle characteristics of the liquid crystal light control device 100B having the structure shown in Table 2. As shown in the graph of FIG. 7, the characteristics of the liquid crystal light control device 100B according to the present embodiment are higher in brightness than the characteristics shown in the fifth embodiment (refer to FIG. 6). The light distribution angle is 52 degrees, which is equivalent to that of the device shown in the reference example of the fifth embodiment. It can be inferred from the characteristics shown in the graph in FIG. 7 that similar characteristics can be obtained even if the cell gap is changed for each liquid crystal cell configuring the liquid crystal light control device 100B. In this manner, the configuration in which the size of the cell gap of the liquid crystal cells configuring the liquid crystal light control device is changed for each liquid crystal cell can also be adopted in the first, third, and fourth embodiments. Not only can the cell gap of the liquid crystal cells having electrodes on both substrates be made larger than the cell gap of the liquid crystal cells having electrodes on only one substrate, but the configuration in which the sizes of the cell gaps of the liquid crystal cells having electrodes on only one substrate are also different can also be adopted.

As shown in this embodiment, it is possible to improve the transmittance and reduce the amount of liquid crystal material used by reducing the cell gap of the liquid crystal cell, which has electrodes arranged on only one side of a pair of substrates. In this way, it is possible to miniaturize the lighting device and improve the brightness while maintaining the same power consumption.

### Seventh Embodiment

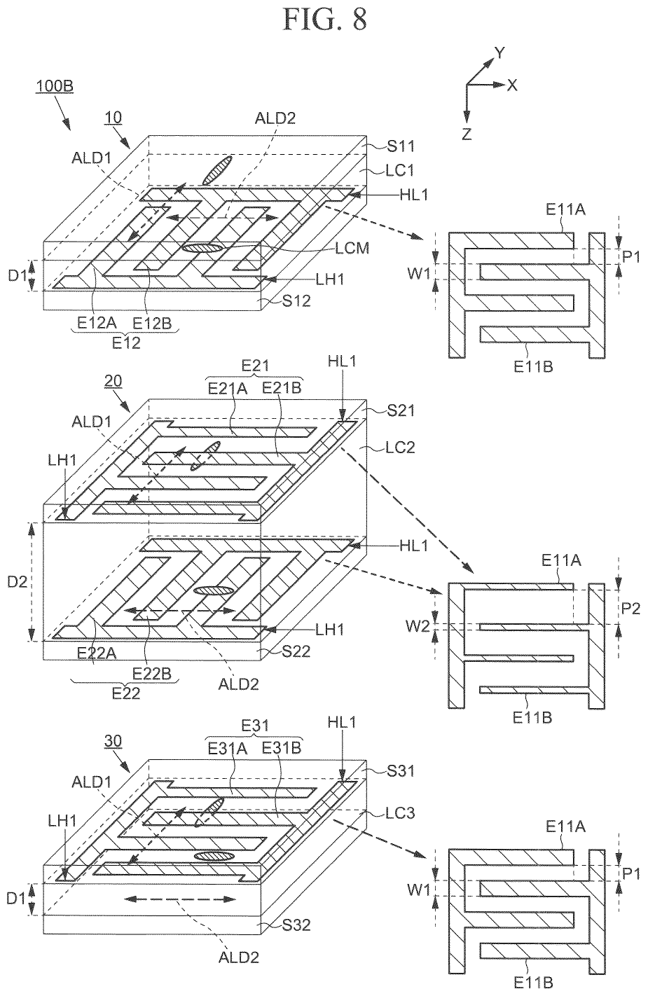

This embodiment shows the light distribution characteristics when the width and spacing of the electrodes of the liquid crystal cell are changed in the liquid crystal light control device 100B shown in the second embodiment. FIG. 8 shows the configuration of the liquid crystal light control device 100B used for evaluation. As shown in FIG. 8, the cell gap D2 of the second liquid crystal cell 20 is larger than the cell gaps D1 of the first liquid crystal cell 10 and the third liquid crystal cell 30. The electrode width W1 and electrode spacing P1 of the first liquid crystal cell 10 and the third liquid crystal cell 30 are such that the electrode width W2 and electrode spacing P2 of the second liquid crystal cell 20 satisfy the relationships W1>W2, and P1>P2. The relationship between the cell gaps D1 of the first liquid crystal cell 10 and the third liquid crystal cell 30 and the electrode width W1 and the electrode spacing P1 is designed so that the value of W1+P1 is approximately equal to D1. Similarly, the cell gap D2 of the second liquid crystal cell 20 is designed so that the value of W2+P2 is approximately equal to D2 with respect to the electrode width W2 and the electrode spacing P2. As a specific example, as shown in Table 3, the electrode width/spacing of an electrode of the first liquid crystal cell 10 and the third liquid crystal cell 30 are 8 μm/8 μm, and the electrode width/electrode spacing of the second liquid crystal cell 20 are 4 μm/24 μm. Since the first liquid crystal cell 10 and the third liquid crystal cell 30 are configured so that electrodes are arranged only on one substrate, the electric field formed by the electrodes on the substrate does not affect the electric field formation on the other substrate, as in the case of the second liquid crystal cell 20. In such a liquid crystal cell with an electrode on one side, the cell gap can be smaller than twice the electrode spacing. On the other hand, for the liquid crystal cell in which electrodes are arranged on both substrates as in the second liquid crystal cell, it is still desirable to provide a cell gap larger than twice the electrode spacing.

TABLE 3

| | Cell Gap | Width/Spacing of Electrode |
|---|---|---|
| 1st liquid crystal cell (10) | 15 μm | 8 μm/8 μm |
| 2nd liquid crystal cell (20) | 55 μm | 4 μm/24 μm |
| 3rd liquid crystal cell (30) | 15 μm | 8 μm/8 μm |

| | |
|---|---|
| Light Distribution Angle | 47 degrees |

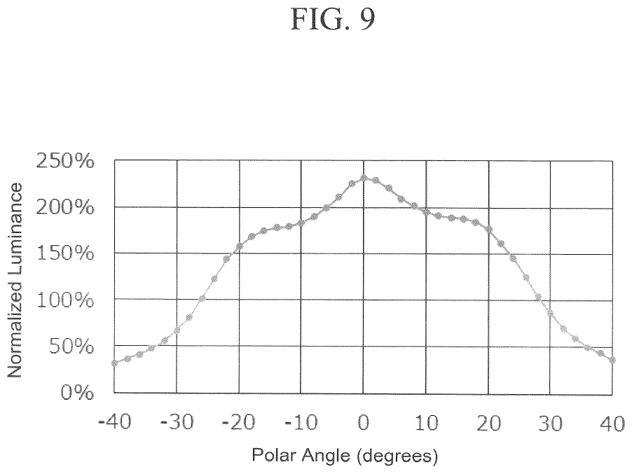

FIG. 9 shows luminance versus angle characteristics of the liquid crystal light control device 100B having the structure shown in Table 3. As shown in the graph in FIG. 9, the characteristics of the liquid crystal light control device 100B according to the present embodiment have higher brightness than the characteristics shown in the fifth embodiment (refer to FIG. 7), and it can be seen that the region where the brightness change is small (the flat curve in the graph) extends in the region where the polar angle is small. The light distribution angle is 47 degrees, which is sufficient for practical use.

In this embodiment, the configuration in which the electrode width of the second liquid crystal cell 20 is the same size as the electrodes arranged in the first liquid crystal cell 10 and the third liquid crystal cell 30 may also be adopted.

As shown in this embodiment, the light distribution characteristics can be changed by changing the electrode width and electrode spacing of the liquid crystal cell. In particular, it is possible to expand the region with high brightness and uniformity by narrowing the electrode width and widening the electrode spacing of a liquid crystal cell with a large cell gap.

The configuration of changing the cell gap, electrode width, and electrode spacing of the liquid crystal cell shown in this embodiment can be similarly applied to the liquid crystal light control devices shown in the first, third, and fourth embodiments.

The various configurations of the liquid crystal light control device illustrated as an embodiment of the present invention may be combined as appropriate as long as they are not mutually contradictory. Based on the liquid crystal light control device disclosed in this specification and the drawings, the scope of the present invention includes those in which a person skilled in the art adds, deletes, or redesigns components as appropriate, or adds, omits, or changes conditions of processes, as long as they embody the essence of the present invention.

It should be understood that other advantageous effects, even if different from those described in the present specification, which are apparent from the description of the present specification or can be easily predicted by those skilled in the art, are also provided by the present invention.

What is claimed is:

1. A liquid crystal light control device comprising:
a first liquid crystal cell;
a second liquid crystal cell; and
a third liquid crystal cell,
each of the first liquid crystal cell, the second liquid crystal cell, and the third liquid crystal cell comprising:
a first substrate arranged on a light incident side;
a second substrate arranged on a light output side; and
a liquid crystal layer between the first substrate and the second substrate,
the first liquid crystal cell, the second liquid crystal cell, and the third liquid crystal cell are arranged overlapping each other in the direction of light emission from a light source,
the first liquid crystal cell includes a first electrode comprising a first strip electrode and a second strip electrode arranged on one of the first substrate and the second substrate,
the second liquid crystal cell includes a first electrode comprising a first strip electrode and a second strip electrode arranged on the first substrate, and a second electrode comprising a third strip electrode and a fourth strip electrode arranged on the second substrate, and
the third liquid crystal cell includes a first electrode comprising a first strip electrode and a second strip electrode arranged on one of the first substrate and the second substrate.

2. The liquid crystal light control device according to claim 1, wherein the first liquid crystal cell, the second liquid crystal cell, and the third liquid crystal cell are arranged in this order in the direction of light emission from the light source,
the first electrode of the first liquid crystal cell is arranged on the first substrate of the first liquid crystal cell, and
the first electrode of the third liquid crystal cell is arranged on the second substrate of the third liquid crystal cell.

3. The liquid crystal light control device according to claim 2, wherein
an extending direction of the first strip electrode and the second strip electrode of the second liquid crystal cell intersects with an extending direction of the third strip electrode and the fourth strip electrode of the second liquid crystal cell,
the direction of the first strip electrode and the second strip electrode of the first liquid crystal cell are the same as the direction of the first strip electrode and the second strip electrode of the second liquid crystal cell, and
the direction of the first strip electrode and the second strip electrode of the third liquid crystal cell are the same as the direction of the third strip electrode and the fourth strip electrode of the second liquid crystal cell.

4. The liquid crystal light control device according to claim 1, wherein the first liquid crystal cell, the second liquid crystal cell, and the third liquid crystal cell are arranged in this order in the direction of light emission from the light source,
the first electrode of the first liquid crystal cell is arranged on the second substrate of the first liquid crystal cell, and
the first electrode of the third liquid crystal cell is arranged on the first substrate of the third liquid crystal cell.

5. The liquid crystal light control device according to claim 4, wherein
an extending direction of the first strip electrode and the second strip electrode of the second liquid crystal cell intersects with an extending direction of the third strip electrode and the fourth strip electrode of the second liquid crystal cell,
an extending direction of the first strip electrode and the second strip electrode of the first liquid crystal cell intersects with an extending direction of the first strip electrode and the second strip electrode of the second liquid crystal cell, and
an extending direction of the first strip electrode and the second strip electrode of the third liquid crystal cell intersects with an extending direction of the third strip electrode and the fourth strip electrode of the second liquid crystal cell.

6. The liquid crystal light control device according to claim 1, wherein the first liquid crystal cell, the third liquid crystal cell, and the second liquid crystal cell are arranged in this order in the direction of light emission from the light source,
the first electrode of the first liquid crystal cell is arranged on the second substrate of the first liquid crystal cell, and
the first electrode of the third liquid crystal cell is arranged on the second substrate of the third liquid crystal cell.

7. The liquid crystal light control device according to claim 6, wherein
an extending direction of the first strip electrode and the second strip electrode of the second liquid crystal cell intersects with an extending direction of the third strip electrode and the fourth strip electrode of the second liquid crystal cell,
an extending direction of the first strip electrode and the second strip electrode of the first liquid crystal cell are the same as an extending direction of the first strip electrode and the second strip electrode of the second liquid crystal cell, and
an extending direction of the first strip electrode and the second strip electrode of the third liquid crystal cell are the same as an extending direction of the third strip electrode and the fourth strip electrode of the second liquid crystal cell.

8. The liquid crystal light control device according to claim 1, wherein the first liquid crystal cell, the third liquid crystal cell, and the second liquid crystal cell are arranged in this order in the direction of light emission from the light source,
the first electrode of the first liquid crystal cell is arranged on the first substrate of the first liquid crystal cell, and
the first electrode of the third liquid crystal cell is arranged on the first substrate of the third liquid crystal cell.

9. The liquid crystal light control device according to claim 8, wherein
an extending direction of the first strip electrode and the second strip electrode of the second liquid crystal cell intersects with an extending direction of the third strip electrode and the fourth strip electrode of the second liquid crystal cell,
an extending direction of the first strip electrode and the second strip electrode of the first liquid crystal cell intersects with an extending direction of the first strip electrode and the second strip electrode of the second liquid crystal cell, and
an extending direction of the first strip electrode and the second strip electrode of the third liquid crystal cell intersects with an extending direction of the third strip electrode and the fourth strip electrode of the second liquid crystal cell.

10. The liquid crystal light control device according to claim 1, wherein a cell gap of the second liquid crystal cell is larger than cell gaps of the first liquid crystal cell and the third liquid crystal cell.

11. The liquid crystal light control device according to claim 10, wherein a distance between the first strip electrode and the second strip electrode and a distance between the third strip electrode and the fourth strip electrode of the second liquid crystal cell are larger than a distance between the first strip electrode and the second strip electrode of the first liquid crystal cell, and a distance between the first strip electrode and the second strip electrode of the third liquid crystal cell.

12. The liquid crystal light control device according to claim 1, further comprising a first alignment film arranged on the first substrate and a second alignment film arranged on the second substrate, in each of the first liquid crystal cell, the second liquid crystal cell, and the third liquid crystal cell,
wherein an alignment direction of the first alignment film intersects with an alignment direction of the second alignment film.

13. The liquid crystal light control device according to claim 1, wherein the liquid crystal layer is comprised of a TN (twisted nematic) liquid crystal.

14. A lighting device comprising:
a liquid crystal light control device including a first liquid crystal cell, a second liquid crystal cell, and a third liquid crystal cell; and
a light source,
each of the first liquid crystal cell, the second liquid crystal cell, and the third liquid crystal cell comprising:
a first substrate arranged on a light incident side;
a second substrate arranged on a light output side; and
a liquid crystal layer between the first substrate and the second substrate,
the first liquid crystal cell, the second liquid crystal cell, and the third liquid crystal cell are arranged overlapping each other in the direction of light emission from the light source,
the first liquid crystal cell includes a first electrode comprising a first strip electrode and a second strip electrode arranged on one of the first substrate and the second substrate,
the second liquid crystal cell includes a first electrode comprising a first strip electrode and a second strip electrode arranged on the first substrate, and a second electrode comprising a third strip electrode and a fourth strip electrode arranged on the second substrate, and
the third liquid crystal cell includes a first electrode comprising a first strip electrode and a second strip electrode arranged on one of the first substrate and the second substrate,
wherein the liquid crystal light control device is arranged on an optical path of light emitted from the light source.

15. The lighting device according to claim 14, wherein the first liquid crystal cell, the second liquid crystal cell, and the third liquid crystal cell are arranged in this order in the direction of light emission from the light source,
the first electrode of the first liquid crystal cell is arranged on the first substrate of the first liquid crystal cell, and
the first electrode of the third liquid crystal cell is arranged on the second substrate of the third liquid crystal cell.

16. The lighting device according to claim 14, wherein the first liquid crystal cell, the second liquid crystal cell, and the third liquid crystal cell are arranged in this order in the direction of light emission from the light source,
the first electrode of the first liquid crystal cell is arranged on the second substrate of the first liquid crystal cell, and
the first electrode of the third liquid crystal cell is arranged on the first substrate of the third liquid crystal cell.

17. The lighting device according to claim 14, wherein the first liquid crystal cell, the third liquid crystal cell, and the second liquid crystal cell are arranged in this order in the direction of light emission from the light source,
the first electrode of the first liquid crystal cell is arranged on the second substrate of the first liquid crystal cell, and
the first electrode of the third liquid crystal cell is arranged on the second substrate of the third liquid crystal cell.

18. The lighting device according to claim 14, wherein the first liquid crystal cell, the third liquid crystal cell, and the second liquid crystal cell are arranged in this order in the direction of light emission from the light source,
the first electrode of the first liquid crystal cell is arranged on the first substrate of the first liquid crystal cell, and
the first electrode of the third liquid crystal cell is arranged on the first substrate of the third liquid crystal cell.

19. The lighting device according to claim 14, wherein a cell gap of the second liquid crystal cell is larger than cell gaps of the first liquid crystal cell and the third liquid crystal cell.

20. The lighting device according to claim 19, wherein a distance between the first strip electrode and the second strip electrode and a distance between the third strip electrode and the fourth strip electrode of the second liquid crystal cell are larger than a distance between the first strip electrode and the second strip electrode of the first liquid crystal cell, and a distance between the first strip electrode and the second strip electrode of the third liquid crystal cell.
